(19) United States
(12) Patent Application Publication
(10) Pub. No.: US 2012/0192740 A1
(43) Pub. Date: Aug. 2, 2012

(54) FOUNTAIN SOLUTION COMPOSITION FOR LITHOGRAPHIC PRINTING PLATE AND LITHOGRAPHIC PRINTING METHOD

(76) Inventors: Takashi Miyazaki, Tokyo (JP); Yuichiro Konishi, Tokyo (JP)

(21) Appl. No.: 13/359,814

(22) Filed: Jan. 27, 2012

(30) Foreign Application Priority Data
Jan. 28, 2011 (JP) 2011-016075
Mar. 16, 2011 (JP) 2011-058218

(51) Int. Cl. B41F 1/18

(52) U.S. Cl. 101/450.1; 101/463.1

(57) ABSTRACT

The invention provides a fountain solution composition for a lithographic printing plate, and a lithographic printing method, that eliminate problems with the printing properties of lithographic printing plates that do not require developing treatment during plate making, and particularly lead edge toning, wherein ink gradually accumulates at the tips of printing plates and the ink is transferred to printed sheet surfaces, and that do not exhibit problems with ink receptivity or printing durability. The invention relates to a fountain solution composition for a lithographic printing plate, comprising at least one polyols, to be used at a working concentration such that the concentration of the polyol is 1.5-25 mass % when printing using a lithographic printing plate that does not require developing treatment during plate making.

### BACKGROUND OF THE INVENTION

1. Field of the Invention

The present invention relates to a fountain solution composition for a lithographic printing plate, to be used for printing using a lithographic printing plate that does not require developing treatment during plate making.

2. Description of the Related Art

CTP (computer-to-plate) printing plates, whereby lithographic printing plates are made based on digital signals from computer data, are commonly subjected to direct exposure onto the photosensitive materials using lasers, and developing treatment using developing solutions. However, the treatment of waste generated by developing treatment produces a burden on the environment. Commercial demands have increasingly become focused on global environmental protection in recent years, and improvements in printing plate making systems are highly desired.

Numerous methods have been proposed for making lithographic printing plates without the need for developing treatment. These are known as “pricessless printing plates” since liquid developing treatment is not performed, and as such types of printing plates, there have been proposed types in which image sections or non-image sections are removed by ablation using laser light, types in which image sections are formed by an ink-jet system, and types in which image sections are formed using heat-fusible or thermoplastic fine particles. However, the types that utilize ablation have suffered from the problem of contamination of exposure device interiors, due to fly-off of ablated surface layers.

Known lithographic printing original plates, wherein image data is directly printed onto an image-receiving layer by an ink-jet system before use for printing, include types of lithographic printing original plates that are provided with a polymer type image-receiving layer on a water-resistant support. For example, Japanese Unexamined Patent Publication HEI No. 5-204138 discloses a lithographic printing original plate provided with an image-receiving layer comprising a linear organic polymer, Japanese Unexamined Patent Publication No. 2000-108537 discloses a lithographic printing original plate provided with an image-receiving layer comprising a polymer composed of a constituent component with an acid group and a constituent component with an onium group, and Japanese Unexamined Patent Publication No. 2000-233581 discloses a lithographic printing original plate provided with an image-receiving layer comprising a polymer having a pendant group with a diene structure. Also, Japanese Unexamined Patent Publication No. 2006-264093 discloses a lithographic printing original plate provided with an image-receiving layer comprising a surfactant and a hydrophilic polymer that has been crosslinked with a carbodiimide group-containing crosslinking agent. However, such polymer type lithographic printing original plates have not yielded satisfactory image quality, and have also been less than adequate in terms of printing durability and toning resistance.

In addition to the polymer type lithographic printing original plates mentioned above, there are also known lithographic printing original plates having porous image-receiving layers, created by the predominate presence of inorganic fine particles or the like, and examples of such types of image-receiving layers include an image-receiving layer composed of a desensitizing metal powder such as zinc oxide or alumina, disclosed in Japanese Unexamined Patent Publication HEI No. 8-324145, an image-receiving layer with a porous or particulate form for uptake of ink-jet ink, disclosed in Japanese Unexamined Patent Publication HEI No. 9-29926, an image-receiving layer comprising a polymer binder, a pigment that is hydrophilicized with an etching solution such as clay, silica, alumina or the like, and a pigment for formation of irregularities on the surface, disclosed in Japanese Unexamined Patent Publication HEI No. 9-58144, an image-receiving layer having a three-dimensional network structure formed from inorganic fine particles with a mean primary particle size of no greater than 100 nm and a water-soluble resin, disclosed in Japanese Unexamined Patent Publication HEI No. 9-99662, and an image-receiving layer having an inorganic xerogel obtained by applying an inorganic gel dispersion, disclosed in Japanese Unexamined Patent Publication No. 2000-44884.

The use of colloidal silica in porous image-receiving layers is also known in the prior art, and for example, there are disclosed in Japanese Unexamined Patent Publication HEI No. 9-29926 mentioned above, as well as in Japanese Unexamined Patent Publication HEI No. 10-296945 and Japanese Unexamined Patent Publication HEI No. 10-315645, image-receiving layers comprising inorganic fine particles with a mean particle size of 1-6 μm and colloidal silica with a mean primary particle size of 10-50 nm.

Also known is the provision of multiple porous layers on a side with multiple image-receiving layers, and for example, Japanese Unexamined Patent Publication No. 2003-231374 and Japanese Unexamined Patent Publication No. 2004-42531 disclose lithographic printing original plates provided with an undercoat layer, composed primarily of colloidal silica, and a hydrophilic layer, Japanese Unexamined Patent Publication No. 2008-183846 discloses a lithographic printing original plate in which a solvent-absorbing layer containing an inorganic pigment and a resin is laminated with an image-receiving layer containing colloidal silica, and Japanese Unexamined Patent Publication No. 2007-190804 discloses a lithographic printing original plate wherein the inorganic pigment/binder ratio in the image-receiving layer near the support is smaller than the ratio in the image-receiving layer further from the support.

However, one problem common to lithographic printing original plates that utilize such ink-jet systems as mentioned above is that when the ink absorbency of the image-receiving layer is increased to obtain satisfactory printing durability, it is not possible to obtain sufficient toning resistance. This is because, although increasing the ink absorbency of the image-receiving layer allows the image-receiving layer at the image sections to hold more lipophilic component (ink) during printing, thereby improving the printing durability, the increased ink absorbency of the image-receiving layer also causes the image-receiving layer to absorb the fountain solution, so that ink slowly accumulates on the tip portions of the printing plate, thereby causing toning (hereunder reference to simply as “lead edge toning”) as the ink transfers to printed sheet surfaces.

There are also known heat-sensitive lithographic printing plates which can be made without the need for developing treatment, such as the heat-sensitive lithographic printing plates described in Japanese Unexamined Patent Publication No. 2001-180144 and Japanese Unexamined Patent Publication No. 2001-322226. Such lithographic printing plates are also effective as simple printing plate systems, since there is no waste due to development. However, when the lipophilicity of the image-forming layer is increased in a heat-sensitive lithographic printing plate to impart sufficient printing durability (that is, when the content of the heat-fusible fine particles or thermoplastic fine particles in the image-forming layer is increased), the hydrophilicity is reduced at the non-image sections and ink slowly accumulates at the tip portions of the printing plate, causing lead edge toning as ink is transferred onto printed sheet surface. This is because the image sections and the non-image sections of the heat-sensitive lithographic printing plate are on the same layer, with the hydrophilic image-forming layer being heated and utilized for ink-receptive image sections while the non-heated sections are utilized directly for non-image sections.

Improvements have therefore been desired for lithographic printing plates that do not require developing treatment during plate making, which are typically lithographic printing original plates utilizing ink-jet systems or heat-sensitive lithographic printing plates wherein image sections are formed using heat-fusible or thermoplastic fine particles, as mentioned above, in order to avoid the gradual accumulation of ink at the tip portions of the printing plate that leads to lead edge toning as ink is transferred to printed sheet surfaces.

One method for eliminating toning during printing, by means of the fountain solution composition used for the lithographic printing plate, is disclosed in Japanese Unexamined Patent Publication HEI No. 5-301481 (PTL 1). In addition, Japanese Unexamined Patent Publication No. 2010-194761 (PTL 2) discloses a technique of adding a protease to the fountain solution composition, with the aim of improving toning during print out. Also, Japanese Unexamined Patent Publication No. 2000-141940 (PTL 3) describes a fountain solution for a printing plate in which glycerin is added at no greater than 0.5 mass % with respect to the working solution and colloidal silica is also contained, as a fountain solution suitable for a printing plate with low water holding capacity. In addition, Japanese Unexamined Patent Publication No. 2006-231764 (PTL 4) discloses a dampening solution for lithographic printing plates, containing glycerin in an amount of at least 0.01 mass % and less than 0.2 mass % in the working solution, and further containing propyleneglycol mono-n-butyl ether or dipropyleneglycol mono-n-butyl ether in an amount of at least 0.2 mass % and less than 0.8 mass % in the working solution, as a fountain solution to substitute for isopropyl alcohol-based fountain solutions.

Finally, in Japanese Unexamined Patent Publication No. 2003-312161 (PTL 5) and Japanese Unexamined Patent Publication No. 2004-082593 (PTL 6), and elsewhere, there are described fountain solutions that can be used as substitutes for isopropyl alcohol-based fountain solutions, with an organic solvent such as glycerin optionally added at 0.5-40 mass % or 1-30 mass % in the concentrate.

### CITATION LIST

### Patent Literature

[PTL 1] Japanese Unexamined Patent Publication HEI No. 5-301481
[PTL 2] Japanese Unexamined Patent Publication No. 2010-194761
[PTL 3] Japanese Unexamined Patent Publication No. 2000-141940
[PTL 4] Japanese Unexamined Patent Publication No. 2006-231764
[PTL 5] Japanese Unexamined Patent Publication No. 2003-312161
[PTL 6] Japanese Unexamined Patent Publication No. 2004-82593

### BRIEF SUMMARY OF THE INVENTION

However, when the fountain solution disclosed in PTL 1 is used, no improvement in toning is obtained unless the fountain solution is supplied to the plate surface in excess, while ink receptivity also tends to be exacerbated at the image sections, so that a large amount of waste paper must be generated to obtain proper prints.

With the technique described in PTL 2, the effect of the protease is unstable, often resulting in unstable printing properties. With the fountain solutions described in PTL 3 and PTL 4, a certain effect against moderate toning over the entire paper surface (scumming) and toning at shadow dot sections (dot gain toning) is exhibited, but lead edge toning also results, making it impossible to obtain satisfactory prints.

In light of these problems, it is an object of the invention to provide a fountain solution composition for a lithographic printing plate, and a lithographic printing method, that eliminate problems with the printing properties, and particularly lead edge toning, for lithographic printing plates that do not require developing treatment during plate making, and that do not exhibit problems with ink receptivity or printing durability.

It was found that this object of the invention can be achieved by a fountain solution composition for a lithographic printing plate and a lithographic printing method, as set forth below.

1. A fountain solution composition for a lithographic printing plate,
comprising at least one polyols,
to be used at a working concentration such that the concentration of the polyols is 1.5-25 mass % when printing using a lithographic printing plate that does not require developing treatment during plate making.
   2. A fountain solution composition for a lithographic printing plate,
comprising at least one polyols at 1.5-25 mass %,
to be used for printing using a lithographic printing plate that does not require developing treatment during plate making.
   3. The fountain solution composition for a lithographic printing plate according to the above 1. or 2., wherein at least one of the polyols is glycerin.
   4. The fountain solution composition for a lithographic printing plate according to any one of the above 1. to 3., wherein the fountain solution composition for a lithographic printing plate comprises 2 or more polyols, at least one of the polyols being a polyol with an sp value of no greater than 35.
   5. The fountain solution composition for a lithographic printing plate according to any one of the above 1. to 4., wherein the lithographic printing plate that does not require developing treatment during plate making is a lithographic printing plate made by an ink-jet system.
   6. The fountain solution composition for a lithographic printing plate according to any one of the above 1. to 4., wherein the lithographic printing plate that does not require developing treatment during plate making is a heat-sensitive lithographic printing plate.
   7. A lithographic printing method, the method comprising:
obtaining a fountain solution composition for a lithographic printing plate comprising at least one polyols, and
using the fountain solution composition for a lithographic printing plate at a working concentration such that the concentration of the polyols is 1.5-25 mass %, for printing using a lithographic printing plate that does not require developing treatment during plate making.
   8. A lithographic printing method, the method comprising:
using a fountain solution composition for a lithographic printing plate comprising at least one polyols at 1.5-25 mass % is used for printing using a lithographic printing plate that does not require developing treatment during plate making.
   9. The lithographic printing method according to the above 7. or 8., wherein at least one of the polyols is glycerin.
   10. The lithographic printing method according to any one of the above 7. to 9., wherein the fountain solution composition for a lithographic printing plate comprises 2 or more polyols, at least one of the polyols being a polyol with an sp value of no greater than 35.
   11. The lithographic printing method according to any one of the above 7. to 10., wherein the lithographic printing plate that does not require developing treatment during plate making is a lithographic printing plate made by an ink-jet system.
   12. The lithographic printing method according to any one of the above 7. to 10.,

wherein the lithographic printing plate that does not require developing treatment during plate making is a heat-sensitive lithographic printing plate.

According to the invention it is possible to provide a fountain solution composition for a lithographic printing plate, and a lithographic printing method, that eliminate lead edge toning and do not exhibit problems with ink receptivity or printing durability.

### DETAILED DESCRIPTION OF THE INVENTION

The term “alkyl” as used herein refers to a saturated straight or branched hydrocarbon group, examples of which include methyl, ethyl, propyl, isopropyl, n-butyl, i-butyl, 2-butyl, t-butyl, pentyl, hexyl and decanyl.

The term “alkoxy” refers to a group in which a saturated straight or branched hydrocarbon group as mentioned above is bonded through an oxygen atom.

The term “halogen” refers to chlorine, iodine, fluorine or bromine.

The term “aryl” refers to a monovalent cyclic aromatic hydrocarbon group comprising 1 or 2 fused rings in which at least one ring has an aromatic property, examples of which include phenyl, benzyl, naphthyl and biphenyl.

Embodiments of the invention will now be explained in detail.

### Embodiment 1

### Fountain Solution Composition for a Lithographic Printing Plate

The fountain solution composition for a lithographic printing plate according to this embodiment comprises at least one polyols, and is to be used at a working concentration such that the concentration of the polyol is 1.5-25 mass % when printing using a lithographic printing plate that does not require developing treatment during plate making. The fountain solution composition for a lithographic printing plate according to this embodiment comprises at least one polyols at 1.5-25 mass %, and is to be used when printing using a lithographic printing plate that does not require developing treatment during plate making.

The lithographic printing plate to be used for printing with a fountain solution composition of the invention is a lithographic printing plate that does not require developing treatment during plate making. As mentioned above, such lithographic printing plates include (1) heat-sensitive lithographic printing plates in which image sections or non-image sections are formed by heat, and the heated sections are used as image sections while the non-heated sections are used as non-image sections, and (2) lithographic printing plates that are made with an ink-jet system utilizing image sections where the images are obtained by direct printing of image data on the image-receiving layer.

The heated sections of a heat-sensitive lithographic printing plate are rendered hydrophobic throughout the entire layer and can thus receive ink during printing, but hydrophobic substances are also present even at the non-image sections that are not heated, and therefore the non-image section layer as a whole is not very hydrophilic. Therefore, the non-image sections of the heat-sensitive lithographic printing plate tend toward hydrophobicity, and hence heat-sensitive lithographic printing plates are more prone to toning than other printing plates such as PS plates (Presensitized Plates) or electrophotographic printing plates (pink masters). In addition, lithographic printing original plates that are made by ink-jet systems absorb the fountain solution in the image-receiving layer, and therefore tend to produce toning.

The term “lead edge toning” as used herein refers to the phenomenon of gradual build-up of ink from the tips of the printing plate, such that ink transferred to the printed sheet surface causes scumming on the top sections of prints. Although the mechanism by which lead edge toning occurs is not precisely understood, it is believed to be due to a difference between the amount of fountain solution necessary for the tips of the plate during printing and the amount of fountain solution necessary for the sections other than the tips. This is because lead edge toning can be improved (though with reduced ink layer thickness in the sections other than the tips of the plate) if the amount of fountain solution matching the tips is mechanically supplied to the entire plate surface. As a result of much diligent research, the present inventors have found that this issue can be solved by using a fountain solution composition for a lithographic printing plate according to the invention on the plate surface.

The fountain solution composition for a lithographic printing plate of the invention comprises at least one polyols. The polyols in the fountain solution composition for a lithographic printing plate of the invention may be a polyol with at least one hydroxyl group, a polyol ether, a polyol ester, or a chlorinated derivative thereof. Specific examples of polyols include glycerin, ethylene glycol, diethylene glycol, trimethylene glycol, triethylene glycol, tetraethylene glycol, propylene glycol, dipropylene glycol, tripropylene glycol, tetrapropylene glycol, 1,3-butylene glycol, propyleneglycol mono-n-butyl ether, dipropyleneglycol mono-n-butyl ether and the like, with glycerin being preferred. These may be used alone or in combinations. The fountain solution is supplied as a concentrate in most cases, diluted 5- to 200-fold with water for use during printing. The fountain solution composition for a lithographic printing plate of the invention is diluted as necessary, and used for printing in a working concentration for a polyol concentration of 1.5-25 mass %. A fountain solution composition for a lithographic printing plate comprising at least one polyols at 1.5-25 mass % may also be prepared and used. When the heat-sensitive lithographic printing plate is used for printing, it is preferably used with a polyols concentration of 2-10 mass %. When a lithographic printing original plate made by an ink-jet system is used for printing, it is preferably used with a polyols concentration of 7.5-20 mass %. The fountain solution that has been prepared to a concentration for use in printing, with dilution as necessary, is referred to as the “working solution”. The concentration of a substance in the working solution is its working concentration. The fountain solution supplied in a concentrated state is referred to as the “concentrated fountain solution”.

In the present invention, the fountain solution composition for a lithographic printing plate preferably comprises 2 or more polyols, at least one of the polyols being a polyol with an sp value (solubility parameter) of no greater than 35. The sp value can be calculated, for example, by the following formula (a), based on the values listed in Table 3 of POLYMER HANDBOOK 4th Edition, VII p. 685 by Wiley-Interscience.

spvalue=(ΣE/ΣV)^{1/2} (formula a)

(Here, E represents cohesive energy, with ΣE representing the sum of the cohesive energies. V represents molar volume, with ΣV representing the sum of the molar volumes.)

Specific examples of polyols with sp values of no greater than 35 include tripropylene glycol (sp value: 25.3), propylene glycol (sp value: 32.6), butyltriglycol (sp value: 22.9), tetraethylene glycol (sp value: 26.1), triethylene glycol (sp value: 27.8), diethylene glycol (sp value: 30.6) and propyleneglycol mono-n-butyl ether (sp value: 21.4). The lower limit for the sp value is preferably 20. The working concentration for a polyol with an sp value of no greater than 35 is preferably in a range not exceeding the working concentration of the other polyols used. For example, the ratio of polyols with an sp value exceeding 35 with respect to the polyol with an sp value of no greater than 35 is preferably in the range of 1:1-15:1 (mass ratio).

More specifically, the fountain solution composition for a lithographic printing plate preferably comprises glycerin and a polyol with an sp value of no greater than 35. For example, the fountain solution composition for a lithographic printing plate is preferably one comprising glycerin and a polyol with an sp value of no greater than 35 in a range of 1:1-15:1 (mass ratio).

The fountain solution composition for a lithographic printing plate of the invention, containing the polyol(s) mentioned above, preferably also contains inorganic fine particles with a mean particle size of no greater than 0.1 μm. Such inorganic fine particles may be fine particles of silica, alumina, zirconia, titania or the like, and they may be inorganic fine particles that have been surface-treated with another element or organic compound. Silica fine particles and alumina fine particles are preferred for use among such inorganic fine particles. Colloidal silica may be mentioned as fine particles that are preferred for use. Silica fine particles are marketed as dispersions under the trade names of, for example, SNOWTEX C, SNOWTEX CXS9, SNOWTEX XS, SNOWTEX XL, SNOWTEX YL, SNOWTEX ZL and SNOWTEX MP-2040, by Nissan Chemical Industries, Ltd. Alumina fine particles are marketed as dispersions under the trade names of, for example, Alumina Sol 100 and Alumina Sol 520, by Nissan Chemical Industries, Ltd. The working concentration of inorganic fine particles with a mean particle size of no greater than 0.1 μm in a fountain solution composition for a lithographic printing plate (i.e. in a working solution state) is preferably 0.005-1 mass % and more preferably 0.01-0.5 mass %.

Other components that may be included in the fountain solution composition for a lithographic printing plate include various substances known in the prior art such as desensitizing accelerators, buffering agents, rust-preventive agents, chelators, antifoaming agents, coloring agents and pH regulators. Specific examples of desensitizing accelerators include carboxymethylcellulose, polyvinylpyrrolidone, polyvinylimidazole, polyvinyl methyl ether/maleic anhydride copolymer and carboxymethyl starch. Specific examples of buffering agents include acetic acid and its salts, sulfuric acid and its salts, phosphoric acid and its salts, nitric acid and its salts, nitrous acid and its salts, citric acid and its salts, propionic acid and its salts, malonic acid and its salts, fumaric acid and its salts, maleic acid and its salts, tartaric acid and its salts, ascorbic acid and its salts, adipic acid and its salts, malic acid and its salts, succinic acid and its salts and tannic acid and its salts. Specific examples of rust-preventive agents include benzotriazole and thiosalicylic acid. Specific examples of chelators include ethylenediaminetetraacetic acid and its potassium salts and sodium salts, and 1-hydroxyethane-1,1-diphosphonic acid and its potassium salts and sodium salts. Specific examples of antifoaming agents include silicon-based antifoaming agents. Specific examples of coloring agents include phthalocyanine dyes, Malachite Green and ultramarine. Various acids and alkalis may be used as pH regulators, examples of acids including citric acid, malic acid, tartaric acid, malonic acid, succinic acid, maleic acid, gluconic acid, lactic acid, acetic acid and glycolic acid. Their salts may also be used and examples of which include alkali metal salts, alkaline earth metal salts, ammonium salts and organic amine salts. As alkali agents there may be added sodium hydroxide, potassium hydroxide, ammonia, organic amines and the like, or alkali metal salts, alkaline earth metal salts, ammonium salts or organic amine salts of organic acids may be used in combination therewith, for adjustment to a desired pH value range. The preferred pH range for the fountain solution composition of the invention is 4-7.

The fountain solution composition for a lithographic printing plate of the invention may be produced by mixing the necessary components described above with water.

The lithographic printing plate to be used for printing with a fountain solution composition of the invention is a lithographic printing plate that does not require developing treatment during plate making. The lithographic printing plate of the invention may be any desired lithographic printing plate so long as it does not require developing treatment during plate making. Such lithographic printing plates include (1) heat-sensitive lithographic printing plates in which image sections or non-image sections are formed by heat, and the heated sections are used as image sections while the non-heated sections are used as non-image sections, and (2) lithographic printing plates that are made with an ink-jet system utilizing image sections where the images are obtained by direct printing of image data on the image-receiving layer.

### (1) Heat-Sensitive Lithographic Printing Plate

Heat-sensitive lithographic printing plates that do not require developing treatment during plate making, and wherein image sections and non-image sections are created by heat, include the heat-sensitive lithographic printing plates described in Japanese Unexamined Patent Publication No. 2001-180144 and Japanese Unexamined Patent Publication No. 2001-322226. The method of rendering the image sections hydrophobic by heat may be polymerization of a polymer, or melting of a thermoplastic resin or heat-fusible substance. A preferred heat-sensitive lithographic printing plate to be used for the invention is one having an image-forming layer comprising a thermoplastic resin and a water-soluble polymer compound, on a support. More preferably, the heat-sensitive lithographic printing plate used has a water-resistant support with an image-forming layer comprising a thermoplastic resin, a water-soluble polymer compound and at least one compound selected from among formulas (1) to (4) below. A more preferred heat-sensitive lithographic printing plate to be used for the invention is a heat-sensitive lithographic printing plate having at least 2 image-forming layers comprising a thermoplastic resin and a water-soluble polymer compound on a support, wherein the proportion of the one or more compounds selected from among formulas (1) to (4) with respect to the water-soluble polymer compound in the image-forming layer (A), which is closer to the support than the image-forming layer (B), is higher than the proportion of the one or more compounds selected from among formulas (1) to (4) with respect to the water-soluble polymer compound in the image-forming layer (B), which is furthest from the support.

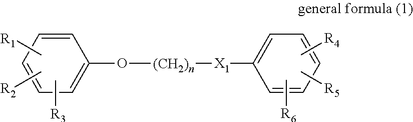

Here,
X₁ represents —O or —CO—O—,
R₁, R₂ and R₃ each independently represent hydrogen, alkyl or aryl, or R₁, R₂ and R₃ are bonded together to form an aromatic ring,
R₄, R₅ and R₆ each independently represent hydrogen, alkyl or aryl, or R₄, R₅ and R₆ are bonded together to form an aromatic ring, and
n represents an integer of 1-10.

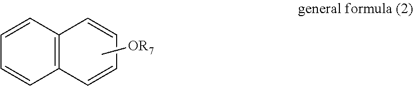

Here, R₇ represents alkyl, aryl, alkylcarbonyl, arylcarbonyl, alkylsulfonyl or arylsulfonyl, and the naphthalene ring in formula (2) may further have an optional substituent.

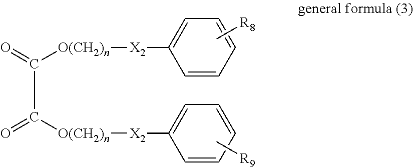

Here, R₈ and R₉ each independently represent hydrogen, a halogen atom, a C1-4 alkyl group or a C₁₋₄ alkoxy group, X₂ represents a single bond or —O—, and n represents an integer of 1-4.

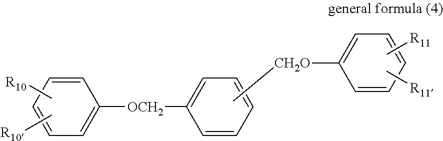

Here, R₁₀, R_{10′}, R₁₁ and R_{11′} each independently represent hydrogen, a halogen atom, alkyl, aryl, alkoxy, alkylcarbonyl, arylcarbonyl, alkoxycarbonyl or aryloxy.

A preferred mode of the heat-sensitive lithographic printing plate of the invention will now be described in detail. The image-forming layer of the heat-sensitive lithographic printing plate comprises a thermoplastic resin. Preferred thermoplastic resins for the image-forming layer of the heat-sensitive lithographic printing plate of the invention are solid organic polymer compounds composed of linear polymers and exhibiting plasticity under heat. The thermoplastic resin of the invention is added as an aqueous dispersion of thermoplastic resin to the coating solution which is to be used to form the image-forming layer, and the coating solution is applied and dried to produce thermoplastic resin particles in the image-forming layer. Typical examples of thermoplastic resins include synthetic rubber latexes such as styrene-butadiene copolymer, acrylonitrile-butadiene copolymer, methyl methacrylate-butadiene copolymer, styrene-acrylonitrile-butadiene copolymer and styrene-methyl methacrylate-butadiene copolymer, as well as their modified forms. Modified forms of synthetic rubber latexes include amino-modified forms, polyether-modified forms, epoxy-modified forms, fatty acid-modified forms, carbonyl-modified forms and carboxy-modified forms. Other examples of thermoplastic resins include styrene-maleic anhydride copolymers, methyl vinyl ether-maleic anhydride copolymers, polyacrylic acid copolymers, polystyrene, styrene-acrylic acid ester copolymers, polyacrylic acid esters, polymethacrylic acid esters, acrylic acid ester-acrylic acid ester copolymers, and low-melting-point polyamide resins. These thermoplastic resins may be used alone or in combinations of two or more. From the viewpoint of affinity with the printing ink vehicle (binder component), the thermoplastic resin is preferably a synthetic rubber latex, and especially styrene-butadiene copolymer or a modified form thereof. The content of the thermoplastic resin in the entire image-forming layer is preferably 5-50 mass % and more preferably 10-40 mass % with respect to the total solid content of the image-forming layer. In order to aid in causing heat-induced melting and a fusing effect, the glass transition temperature of the thermoplastic resin is preferably 50-150° C. and more preferably 55-120° C. If the glass transition temperature of the thermoplastic resin is below 50° C., a phase transition to liquid may take place during the production process and the non-image sections may also exhibit lipophilicity, thus causing print scumming. If the glass transition temperature of the thermoplastic resin exceeds 150° C., the polymer will undergo heat-fusion less readily and it may be difficult to form strong images with relatively low-output lasers or miniature thermal printers.

The image-forming layer in a heat-sensitive lithographic printing plate to be used for the invention comprises a water-soluble polymer compound. Examples of water-soluble polymer compounds that are preferably added to the image-forming layer of the heat-sensitive lithographic printing plate of the invention include polyvinyl alcohol and its modified forms (such as carboxy-modified polyvinyl alcohol, acetoacetyl-modified polyvinyl alcohol and silanol-modified polyvinyl alcohol), hydroxyethylcellulose, methylcellulose, carboxymethylcellulose, polysaccharides including pullulan or starch and its derivatives, gelatin, casein, sodium alginate, polyvinylpyrrolidone, styrene-maleic acid copolymer salts and styrene-acrylic acid copolymer salts. These water-soluble polymer compounds may be used alone or in combinations of two or more. Gelatin or polyvinyl alcohol and its modified forms, which are favorable for film formation, are most preferably selected for retaining the hydrophilicity of the non-image sections. The content of the water-soluble polymer compound in the entire image-forming layer is preferably 0.5-30 mass % and more preferably 3-25 mass %, as the content with respect to the total solid content of the image-forming layer.

For improved water resistance and mechanical strength of the non-image sections, the image-forming layer preferably comprises a curing agent (water resistant additive) selected according to the type of water-soluble polymer compound. The curing agent used may be one that imparts water resistance by promoting resin crosslinking, examples of which include melamine resins, epoxy resins, polyisocyanate compounds, aldehyde compounds, silane compounds, chrome alum and divinylsulfone. Particularly when the water-soluble polymer compound is gelatin, the curing agent is preferably divinylsulfone, and when the water-soluble polymer compound is polyvinyl alcohol, the curing agent is preferably glyoxal. From the viewpoint of obtaining the necessary water resistance and mechanical strength, and also avoiding deterioration of the properties during storage, the content of the curing agent in the entire image-forming layer is preferably 1-30 mass % and more preferably 2-15 mass %, with respect to the solid content of the water-soluble polymer compound.

The image-forming layer of the heat-sensitive lithographic printing plate of the invention preferably comprises at least one compound selected from among formulas (1) to (4), from the viewpoint of printing durability. An even more preferred embodiment is a heat-sensitive lithographic printing plate having at least 2 image-forming layers comprising a thermoplastic resin and a water-soluble polymer compound on a support, wherein the proportion of the one or more compounds selected from among formulas (1) to (4) with respect to the water-soluble polymer compound in the image-forming layer (A), which is closer to the support than image-forming layer (B), is higher than the proportion of the one or more compounds selected from among formulas (1) to (4) with respect to the water-soluble polymer compound in image-forming layer (B), which is furthest from the support. There are no particular restrictions on the method of forming multiple image-forming layers, and for example, the image-forming layer (A) may be coated and the image-forming layer (B) applied over it, or multiple layers may be simultaneously applied by a slide hopper system. Compounds represented by formula (1) will now be described.

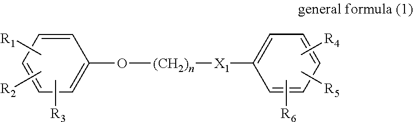

In the formula,
X₁ represents —O or —CO—O—,
R₁, R₂ and R₃ each independently represent hydrogen, alkyl or aryl, or R₁, R₂ and R₃ may be bonded together to form an aromatic ring,
R₄, R₅ and R₆ each independently represent hydrogen, alkyl or aryl, or R₄, R₅ and R₆ may be bonded together to form an aromatic ring, and
n represents an integer of 1-10.

Compounds of formula (1) wherein X₁ is —O— are preferred. More preferably, R₁ and R₆ are each hydrogen or a C₁₋₄ alkyl group, R₂, R₃, R₄ and R₅ are each hydrogen and n is an integer of 1-4 in the compound of formula (1).

The following are examples of compounds represented by formula (1), although there is no limitation to these.
(1) 1-(1-Naphthoxy)-2-phenoxyethane
(2) 1-(2-Naphthoxy)-4-phenoxybutane
(3) 1-(2-Isopropylphenoxy)-2-(2-naphthoxy)ethane
(4) 1-(4-Methylphenoxy)-3-(2-naphthoxy)propane
(5) 1-(2-Methylphenoxy)-2-(2-naphthoxy)ethane
(6) 1-(3-Methylphenoxy)-2-(2-naphthoxy)ethane
(7) 1-(2-Naphthoxy)-2-phenoxyethane
(8) 1-(2-Naphthoxy)-6-phenoxyhexane
(9) 1-Phenoxy-2-(2-phenylphenoxy)ethane
(10) 1-(2-Methylphenoxy)-2-(4-phenylphenoxy)ethane
(11) 1,4-Diphenoxybutane
(12) 1,4-bis(4-Methylphenoxy)butane
(13) 1,2-di(3,4-Dimethylphenoxy)ethane
(14) 1-Phenoxy-3-(4-phenylphenoxy)propane
(15) 1-(4-tert-Butylphenoxy)-2-phenoxyethane
(16) 1,2-Diphenoxyethane
(17) 1-(4-Methylphenoxy)-2-phenoxyethane
(18) 1-(2,3-Dimethylphenoxy)-2-phenoxyethane
(19) 1-(3,4-Dimethylphenoxy)-2-phenoxyethane
(20) 1-(4-Ethylphenoxy)-2-phenoxyethane
(21) 1-(4-Isopropylphenoxy)-2-phenoxyethane
(22) 1,2-bis(2-Methylphenoxy)ethane
(23) 1-(2-Methylphenoxy)-2-(4-methylphenoxy)ethane
(24) 1-(4-tert-Butylphenoxy)-2-(2-methylphenoxy)ethane
(25) 1,2-bis(3-Methylphenoxy)ethane
(26) 1-(3-Methylphenoxy)-2-(4-methylphenoxy)ethane
(27) 1-(4-Ethylphenoxy)-2-(3-methylphenoxy)ethane
(28) 1,2-bis(4-Methylphenoxy)ethane
(29) 1-(2,3-Dimethylphenoxy)-2-(4-methylphenoxy)ethane
(30) 1-(2,5-Dimethylphenoxy)-2-(4-methylphenoxy)ethane
(31) Phenoxy-2-naphthyl acetate
(32) 2-Naphthoxy-4-methylphenyl acetate
(33) 2-Naphthoxy-3-methylphenyl acetate

Compounds represented by formula (2) will now be described.

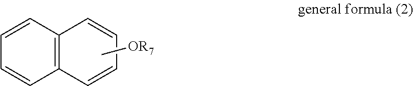

In the formula, R₇ represents alkyl, aryl, alkylcarbonyl, arylcarbonyl, alkylsulfonyl or arylsulfonyl. The naphthalene ring in the formula may have a substituent, with examples of preferred substituents including alkyl, aryl, halogen atoms, hydroxy, alkoxy, aryloxy, alkyloxycarbonyl, alkoxycarbonyl, aryloxycarbonyl, carbamoyl and sulfamoyl.

The compound of formula (2) is more preferably one in which R₇ is a C4-20 alkyl, C4-24 aryl, C2-20 alkylcarbonyl or C7-20 arylcarbonyl group. The compound of formula (2) is more preferably one wherein the optional substituent on the naphthalene ring is a halogen atom, C1-10 alkyl, C2-20 alkyloxycarbonyl, C7-20 aryloxycarbonyl or C2-25 carbamoyl group.

The following are examples of compounds represented by formula (2), although there is no limitation to these.
(1) 1-Benzyloxynaphthalene
(2) 2-Benzyloxynaphthalene
(3) 2-p-Chlorobenzyloxynaphthalene
(4) 2-p-Isopropylbenzyloxynaphthalene
(5) 2-Dodecyloxynaphthalene
(6) 2-Decanoyloxynaphthalene
(7) 2-Myristoyloxynaphthalene
(8) 2-p-tert-Butylbenzoyloxynaphthalene
(9) 2-Benzoyloxynaphthalene
(10) 2-Benzyloxy-3-N-(3-dodecyloxypropyl)carbamoylnaphthalene
(11) 2-Benzyloxy-3-N-octylcarbamoylnaphthalene
(12) 2-Benzyloxy-3-dodecyloxycarbonylnaphthalene
(13) 2-Benzyloxy-3-p-tert-butylphenoxycarbonylnaphthalene

Compounds represented by formula (3) will now be described.

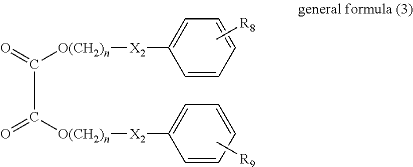

In the formula,

R₈ and R₉ each independently represent hydrogen, a halogen atom, a C1-4 alkyl group or a C1-4 alkoxy group,
X₂ represents a single bond or —O—, and
n represents an integer of 1-4.

The following are examples of compounds represented by formula (3), although there is no limitation to these.
(1) Bisbenzyl oxalate
(2) bis(p-Methylbenzyl)oxalate
(3) bis(p-Chlorobenzyl)oxalate
(4) bis(m-Methylbenzyl)oxalate
(5) bis(p-Ethylbenzyl)oxalate
(6) bis(p-Methoxybenzyl)oxalate
(7) bis(2-Phenoxyethyl)oxalate
(8) bis(2-o-Chlorophenoxyethyl)oxalate
(9) bis(2-p-Chlorophenoxyethyl)oxalate
(10) bis(2-p-Ethylphenoxyethyl)oxalate
(11) bis(2-m-Methoxyphenoxyethyl)oxalate
(12) bis(2-p-Methoxyphenoxyethyl)oxalate
(13) bis(4-Phenoxybutyl)oxalate

Specific preferred examples of such compounds include bisbenzyl oxalate, bis(p-methylbenzyl)oxalate, bis(p-chlorobenzyl)oxalate, bis(m-methylbenzyl)oxalate, bis(p-ethylbenzyl)oxalate and bis(p-methoxybenzyl)oxalate.

Compounds represented by formula (4) will now be described.

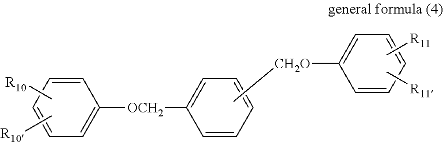

In the formula, R₁₀, R_{10′}, R₁₁ and R_{11′}, each independently represent hydrogen, a halogen atom, alkyl, aryl, alkoxy, alkylcarbonyl, arylcarbonyl, alkoxycarbonyl or aryloxy.

The following are examples of compounds represented by formula (4), although there is no limitation to these.
(1) 1,2-Bisphenoxymethylbenzene
(2) 1,3-Bisphenoxymethylbenzene
(3) 1,4-bis(2-Methylphenoxymethyl)benzene
(4) 1,4-bis(3-Methylphenoxymethyl)benzene
(5) 1,3-bis(4-Methylphenoxymethyl)benzene
(6) 1,3-bis(2,4-Dimethylphenoxymethyl)benzene
(7) 1,3-bis(2,6-Dimethylphenoxymethyl)benzene
(8) 1,4-bis(2-Chlorophenoxymethyl)benzene
(9) 1,2-bis(4-Chlorophenoxymethyl)benzene
(10) 1,3-bis(4-Chlorophenoxymethyl)benzene
(11) 1,2-bis(4-Octylphenoxymethyl)benzene
(12) 1,3-bis(4-Octylphenoxymethyl)benzene
(13) 1,3-bis(4-Isopropylphenylphenoxymethyl)benzene
(14) 1,4-bis(4-Isopropylphenylphenoxymethyl)benzene

Specific preferred examples of such compounds include 1,2-bisphenoxymethylbenzene, 1,4-bis(2-methylphenoxymethyl)benzene, 1,4-bis(3-methylphenoxymethyl)benzene and 1,4-bis(2-chlorophenoxymethyl)benzene.

Particularly preferred compounds among those represented by formulas (1) to (4) are compounds represented by formula (1). Since the compounds represented by formulas (1) to (4) are solid at ordinary temperature, they are preferably used after microdispersion treatment to increase the reactivity under heat. The microdispersion treatment may be carried out with a wet dispersion system commonly used for coating manufacturing, and for example, a roll mill, colloid mill, ball mill, attritor or a bead mill such as a sand mill may be used. The beads for a bead mill may be ceramic beads of zirconia, titania or alumina, metal beads of chromium or steel, or glass beads. The dispersion particle size for a compound obtained by microdispersion treatment is preferably a median diameter of 0.1-1.2 μm and more preferably 0.3-0.8 μm. The median diameter is the particle size (cumulative mean diameter) at the point where the cumulative curve is 50%, the cumulative curve being determined with the total volume of one particle aggregate defined as 100%, and it may be measured using an LA920 laser diffraction/scattering particle size distribution analyzer (Horiba, Ltd.), as a parameter for evaluation of the particle size distribution.

The proportion of the compound represented by formulas (1) to (4) with respect to the water-soluble polymer compound (i.e., the ratio: mass of compound represented by formulas (1) to (4)/mass of water-soluble polymer compound) in the image-forming layer (B) that is furthest from the support is preferably 0-0.5. Also, the proportion of the compound represented by formulas (1) to (4) with respect to the water-soluble polymer compound (i.e., the ratio: mass of compound represented by formulas (1) to (4)/mass of water-soluble polymer compound) in the image-forming layer (A) that is close to the support is preferably 1.0 or greater.

The proportion of the compound represented by formulas (1) to (4) with respect to the water-soluble polymer compound in the image-forming layer (A) that is close to the support in the heat-sensitive lithographic printing plate of the invention may be any proportion that is higher than the same proportion in the image-forming layer (B) that is furthest from the support, but preferably the difference between the proportion in the image-forming layer (A) and the proportion in the image-forming layer (B) is at least 1.0.

When three image-forming layers are to be formed in the heat-sensitive lithographic printing plate of the invention, an image-forming layer (C) may be formed between the image-forming layer (A) and the image-forming layer (B). The proportion of compounds represented by formulas (1) to (4) with respect to the water-soluble polymer compound in the image-forming layer (C) may be either higher or lower than the same proportion in the image-forming layer (B) that is furthest from the support, but it is preferably lower than the proportion in the image-forming layer (A) that is near the support and higher than the proportion in the image-forming layer (B).

The image-forming layer of the heat-sensitive lithographic printing plate of the invention may comprise a heat-fusible substance. The heat-fusible substance is preferably an organic compound with a melting point of 50-150° C., examples of which include waxes such as carnauba wax, microcrystalline wax, paraffin wax and polyethylene wax, fatty acids such as lauric acid, stearic acid, oleic acid, palmitic acid, behenic acid and montanic acid, and their esters and amides. The content of the heat-fusible substance in the entire image-forming layer is preferably 0.5-50 mass % with respect to the total solid content of the image-forming layer.

The image-forming layer of the heat-sensitive lithographic printing plate of the invention may also comprise a light-heat converting substance. Adding a light-heat converting substance will allow writing not only with a thermal head but also with active light from an infrared laser or the like. Light-heat converting substances to be used are preferably materials that efficiently absorb light for conversion to heat. These will depend on the light source used, and for example, when a semiconductor laser that emits near-infrared light is used as the light source, the light-heat converting substance is preferably a near-infrared light absorber with an absorption band in the near-infrared range, examples of which include organic compounds such as carbon black, cyanine-based dyes, polymethine-based dyes, azulenium-based dyes, squalium-based dyes, thiopyrylium-based dyes, naphthoquinone-based dyes and anthraquinone-based dyes, and metal compounds including phthalocyanine-based, azo-based and thioamide-based organometallic complexes, iron powder, graphite powder, iron oxide powder, lead oxide, silver oxide, chromium oxide, iron sulfide and chromium sulfide.

In order to ensure visibility, the image-forming layer of the heat-sensitive lithographic printing plate of the invention may contain developers or coloring agents (electron-donating dye precursors), such as phenol derivatives or aromatic carboxylic acid derivatives, that are commonly used in thermal recording paper or pressure sensitive paper.

Specific examples of developers to be used in the image-forming layer for heat-sensitive lithographic printing plate according to the invention include phenolic compounds such as 4-cumylphenol, hydroquinone monobenzyl ether, 4,4′-isopropylidenediphenol, 1,1-bis(4-hydroxyphenyl)cyclohexane, 4,4′-dihydroxydiphenyl-2,2-butane, 4,4′-dihydroxydiphenylmethane, 2,2-bis(4-hydroxyphenyl)-4-methylpentane, 2,2-bis(4-hydroxyphenyl)heptane, bis(4-hydroxyphenylthioethoxy)methane, 1,5-di(4-hydroxyphenylthio)-3-oxapentane, 1,1-bis(4-hydroxyphenyl)-1-phenylethane, 1,4-bis[α-methyl-α-(4′-hydroxyphenyl)ethyl]benzene, 1,3-bis[α-methyl-α-(4′-hydroxyphenyl)ethyl]benzene, 4,4′-dihydroxydiphenyl sulfide, di(4-hydroxy-3-methylphenyl)sulfone, 4-hydroxy-4′-methyldiphenylsulfone, 4-hydroxy-4′-isopropoxydiphenylsulfone, 2,4′-dihydroxydiphenylsulfone, 4,4′-dihydroxydiphenylsulfone, bis(3-allyl-4-hydroxyphenyl)sulfone, 4-hydroxyphenyl-4′-benzyloxyphenylsulfone, 4-hydroxy-3′,4′-tetramethylenebiphenylsulfone, 3,4-dihydroxyphenyl-p-tolylsulfone, 4,4′-dihydroxybenzophenone, benzyl 4-hydroxybenzoate, N,N′-di-m-chlorophenylthiourea and N-(phenoxyethyl)-4-hydroxyphenylsulfonamide; zinc salts of aromatic carboxylic acids such as 4-[3-(p-tolylsulfonyl)propyloxy]zinc salicylate, 4-[2-(p-methoxyphenoxy)ethyloxy]zinc salicylate, 5-[p-(2-p-methoxyphenoxyethoxy)cumyl]zinc salicylate and zinc p-chlorobenzoate; and organic acidic substances such as antipyrine complex of zinc thiocyanate.

Specific examples of coloring agents (electron-donating dye precursors) to be used in the heat-sensitive lithographic printing plate of the invention include (1) triarylmethane-based compounds, including 3,3′-bis(p-dimethylaminophenyl)-6-dimethylaminophthalide (crystal violet lactone), 3,3′-bis(p-dimethylaminophenyl)phthalide, 3-(p-dimethylaminophenyl)-3-(1,2-dimethylindol-3-yl)phthalide, 3-(p-dimethylaminophenyl)-3-(2-methylindol-3-yl)phthalide, 3-(p-dimethylaminophenyl)-3-(2-phenylindol-3-yl)phthalide, 3,3-bis-(1,2-dimethylindol-3-yl)-5-dimethylaminophthalide, 3,3-bis(1,2-dimethylindol-3-yl)-6-dimethylaminophthalide, 3,3-bis(9-ethylcarbazol-3-yl)-5-dimethylaminophthalide, 3,3-bis(2-phenylindol-3-yl)-5-dimethylaminophthalide and 3-p-dimethylaminophenyl-3-(1-methylpyrrol-2-yl)-6-dimethyl-aminophthalide; (2) diphenylmethane-based compounds, including 4,4′-bis-dimethylaminobenzhydrin benzyl ether, N-halophenyl leuco auramine and N-2,4,5-trichlorophenyl leuco auramine; (3) xanthene-based compounds, including rhodamine B-anilinolactam, rhodamine B-p-nitroanilinolactam, rhodamine B-p-chloroanilinolactam, 3-diethylamino-7-dibenzylaminofluorane, 3-diethylamino-7-octylaminofluorane, 3-diethylamino-7-phenylfluorane, 3-diethylamino-7-(3,4-dichloroanilino)fluorane, 3-diethylamino-7-(2-chloroanilino)fluorane, 3-diethylamino-6-methyl-7-anilinofluorane, 3-dibutylamino-6-methyl-7-anilinofluorane, 3-piperidino-6-methyl-7-anilinofluorane, 3-ethyl-tolylamino-6-methyl-7-anilinofluorane, 3-ethyl-tolylamino-6-methyl-7-phenethylfluorane and 3-diethylamino-7-(4-nitroanilino)fluorane; (4) thiazine-based compounds, including benzoyl leuco methylene blue and p-nitrobenzoyl leuco methylene blue; and (5) spiro-based compounds, including 3-methyl-spiro-dinaphthopyran, 3-ethyl-spiro-dinaphthopyran, 3,3′-dichloro-spiro-dinaphthopyran, 3-benzyl-spiro-dinaphthopyran, 3-methylnaphtho-(3-methoxy-benzo)-spiropyran and 3-propyl-spiro-dibenzopyran. These may be used either alone or in combinations of two or more.

The coating amount for the entire image-forming layer on the heat-sensitive lithographic printing plate of the invention is preferably to a dry film thickness of 0.5-20 μm and more preferably 1-10 μm, from the viewpoint of image section printing durability, non-image section water resistance and mechanical strength.

The support of the heat-sensitive lithographic printing plate of the invention is preferably a water-resistant support, as a property for use in a printing plate, and for example, a plastic film, resin-covered sheet or waterproof sheet may be used. Specifically, there may be used plastic films, including polyolefins such as polyethylene or polypropylene, polyethersulfone, polyester, poly(meth)acrylate, polycarbonate, polyamide and polyvinyl chloride; laminated or coated resin-covered sheets having such plastics covering the surfaces, and sheets that have been waterproofed by wet strength agents such as melamine-formaldehyde resins, urea-formaldehyde resins or epoxidated polyamide resins.

Other materials such as plastic films, metal sheets (such as iron, stainless steel or aluminum) or polyethylene-coated sheets (including composite base materials) may also be laminated as appropriate for use as a composite support. Such composite base materials may be laminated before forming the heat-sensitive layer of the invention, or laminated after forming the heat-sensitive layer, or laminated immediately before mounting on the printer.

The thickness of the support is preferably about 100-300 μm from the viewpoint of suitability for recording with heat-sensitive printers and suitability for lithographic printers.

The surface of the water-resistant support may be subjected to adhesion-promoting treatment such as plasma treatment, corona discharge treatment or far ultraviolet irradiation treatment to increase adhesion with the heat-sensitive layer or with interlayers that may be provided as necessary and appropriate, or to treatment to form an under coating layer.

The heat-sensitive lithographic printing plate of the invention may be produced by employing a known coating method to coat the support with a coating solution comprising the materials for the image-forming layer mixed and dissolved or dispersed in an appropriate solvent, and then drying it. The solvent is preferably water. However, the drying process is preferably carried out in an atmosphere of no higher than 50° C. for about 30 seconds to 10 minutes so that the image-forming layer (and interlayer) is not denatured by heat during the drying.

A plate making method using the aforementioned heat-sensitive lithographic printing plate according to the invention will now be described. The heat-sensitive lithographic printing plate of the invention has a heat-sensitive image-forming layer. When the image-forming layer in the heat-sensitive lithographic printing plate of the invention contains a light-heat converting substance, image sections can be formed by exposure to light that includes infrared light of 760 nm to 1200 nm, for example. The image sections are more preferably formed by using a solid-state laser and semiconductor laser that emit infrared radiation. Laser exposure, in particular, allows desired image patterns to be recorded directly from digital information in a computer. The heat-sensitive lithographic printing plate of the invention also allows the image-forming layer to be subjected directly to thermal lithography by using a thermal head, heat block or the like to form image sections. By using a thermal head, desired image patterns can be recorded directly from digital information in a computer.

In the case of a thermal head, there may be used a line printer that employs a thick or thin film line head, or a serial printer that employs a thin film serial head. The recording energy density is preferably 10-100 mJ/mm². The head preferably has an image recording density of at least 300 dpi so as to obtain output images with relatively high quality.

### (2) Lithographic Printing Plate Made by Ink-Jet System

A lithographic printing original plate made by an ink-jet system will now be described. Examples of lithographic printing original plates made by ink-jet systems include lithographic printing original plates with polymer type image-receiving layers, described in Japanese Unexamined Patent Publication HEI No. 5-204138 and Japanese Unexamined Patent Publication No. 2001-108537 mentioned above, lithographic printing original plates with porous image-receiving layers, described in Japanese Unexamined Patent Publication HEI No. 8-324145 and Japanese Unexamined Patent Publication HEI No. 9-99662, lithographic printing original plates with porous image-receiving layers containing colloidal silica, described in Japanese Unexamined Patent Publication HEI No. 10-296945 and Japanese Unexamined Patent Publication No. 10-315645, and lithographic printing original plates having multiple porous layers, described in Japanese Unexamined Patent Publication No. 2003-231374 and Japanese Unexamined Patent Publication No. 2008-183846. Preferred lithographic printing original plates made by ink-jet systems include lithographic printing original plates with an image-receiving layer composed mainly of cationic colloidal silica, or composed mainly of colloidal silica and containing a cationic compound, on a water-resistant support. A preferred lithographic printing original plate will now be described.

A preferred image-receiving layer is composed mainly of cationic colloidal silica, or is composed mainly of colloidal silica and contains a cationic compound. Here, “composed mainly of” means that the mass ratio of the cationic colloidal silica or colloidal silica with respect to the total solid mass of the image-receiving layer is 50 mass % or greater, preferably 70 mass % or greater and more preferably 85 mass % or greater. The image-receiving layer is more preferably a layer composed mainly of cationic colloidal silica with a mean primary particle size of at least 30 nm, or composed mainly of nonspherical cationic colloidal silica, from the viewpoint of printing durability.

When the image-receiving layer is a layer composed mainly of nonspherical cationic colloidal silica, the nonspherical cationic colloidal silica preferably has a mean primary particle size of 25-60 nm, with a mean secondary particle size/mean primary particle size ratio of 1.4-3.1. This will allow a lithographic printing plate with more excellent printing durability to be obtained.

The phrase “a mean secondary particle size/mean primary particle size ratio of 1.4-3.1”, as used herein, includes the concept of 2-3 primary particles of colloidal silica joined together, but does not include 5 or more. Two different types of colloidal silica may even be used, so long as the mean primary particle size of each colloidal silica is 25-60 nm and the mean secondary particle size/mean primary particle size ratio is 1.4-3.1. The “mean primary particle size of colloidal silica”, as used herein, is the mean particle size of 100 particles present within a prescribed area of an electron micrograph of particles dispersed to a degree allowing the primary particle sizes to be discriminated. The mean secondary particle size of the colloidal silica is the diameter of joined colloidal silica, which may be determined as the number median diameter using a laser scattering particle size distribution meter (for example, an LA910 by Horiba, Ltd.). The mean secondary particle size/mean primary particle size ratio of colloidal silica is calculated as the ratio of the diameter of joined colloidal silica, determined as the number median diameter using a laser scattering particle size distribution meter (for example, an LA910 by Horiba, Ltd.), with respect to the mean primary particle size obtained as explained above.

The method for obtaining such colloidal silica may be modification of the surface of colloidal silica with a cationic polymer and water-soluble polyvalent metal compound, or a cationic silane coupling agent as mentioned below, or introduction of cationic groups onto the particle surfaces during the process of producing colloidal silica. The colloidal silica used for modification of the surface of colloidal silica may be of the QUARTRON PL Series by Fuso Chemical Co., Ltd., or CATALOID SI-50 by JGC Catalysts and Chemicals, Ltd. A method of modification of the surface of colloidal silica using a water-soluble polyvalent metal compound is more preferable as the method for obtaining the colloidal silica.

The cationic silane coupling agent is preferably an amino group-containing silane coupling agent. Examples of silane coupling agents include N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane and γ-aminopropyltriethoxysilane.

The solid mass mixing ratio of the cationic polymer or water-soluble polyvalent metal compound modifying the cationic colloidal silica (parts by mass of colloidal silica/parts by mass of cationic polymer or water-soluble polyvalent metal compound) is preferably 100/2-100/20 and more preferably 100/5-100/15. The solid mass mixing ratio of a coupling agent, when the colloidal silica is treated with a coupling agent (parts by mass of colloidal silica/parts by mass of coupling agent) is preferably 100/0.01-100/20 and more preferably 100/0.05-100/10.

From the viewpoint of printing durability, the image-receiving layer most preferably is composed mainly of cationic colloidal silica with a mean primary particle size of 30 nm or greater (cationic colloidal silica having spherical primary particles as the colloidal particles, and having a mean primary particle size of 30 nm or greater).

Cationic colloidal silica is commercially available, for example, as SILICA LGT by Lion Corp., FINE CATALOID by JGC Catalysts and Chemicals, Ltd., or ST-AK-L, ST-UP-AK, ST-PS-M-AK or ST-AK-YL by Nissan Chemical Industries, Ltd., and any of these commercial products may be obtained and utilized. The mean primary particle size of the cationic colloidal silica is preferably no greater than 300 nm from the viewpoint of printing durability.

Colloidal silica to be used with the cationic compound in the image-receiving layer is, specifically, anionic colloidal silica, and its mean primary particle size is preferably the same as the aforementioned cationic colloidal silica. Such anionic colloidal silica is available for use as SNOWTEX ST-20, ST-30, ST-C, ST-OL40 or ST-OZL by Nissan Chemical Industries, Ltd., or as PL-3 L, PL-5 or PL-7 by Fuso Chemical Co., Ltd.

The cationic compound to be used together with the colloidal silica in the image-receiving layer may be a cationic polymer or a water-soluble polyvalent metal compound. Cationic polymers and water-soluble polyvalent metal compounds may also be used for modification of the silica surface, when preparing nonspherical cationic colloidal silica.

As cationic polymers there are preferred polyethyleneimine, polydiallylamine, polyallylamine, alkylamine polymers, and the polymers having primary to tertiary amino groups and quaternary ammonium salt groups, mentioned in Japanese Unexamined Patent Publication SHO No. 59-20696, Japanese Unexamined Patent Publication SHO No. 59-33176, Japanese Unexamined Patent Publication SHO No. 59-33177, Japanese Unexamined Patent Publication SHO No. 59-155088, Japanese Unexamined Patent Publication SHO No. 60-11389, Japanese Unexamined Patent Publication SHO No. 60-49990, Japanese Unexamined Patent Publication SHO No. 60-83882, Japanese Unexamined Patent Publication SHO No. 60-109894, Japanese Unexamined Patent Publication SHO No. 62-198493, Japanese Unexamined Patent Publication SHO No. 63-49478, Japanese Unexamined Patent Publication SHO No. 63-115780, Japanese Unexamined Patent Publication SHO No. 63-280681, Japanese Unexamined Patent Publication HEI No. 1-40371, Japanese Unexamined Patent Publication HEI No. 6-234268, Japanese Unexamined Patent Publication HEI No. 7-125411 and Japanese Unexamined Patent Publication HEI No. 10-193776. The molecular weight of the cationic polymer is preferably about 1000-100,000.

Water-soluble polyvalent metal compounds include water-soluble polyvalent metal salts, including water-soluble salts of metals selected from among calcium, barium, manganese, copper, cobalt, nickel, aluminum, iron, zinc, zirconium, chromium, magnesium, tungsten and molybdenum. Specifically, these include calcium acetate, calcium chloride, calcium formate, calcium sulfate, barium acetate, barium phosphate, manganese chloride, manganese acetate, manganese formate dihydrate, ammonium manganese sulfate hexahydrate, copper(II) chloride, ammonium copper(II) chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, nickel phenolsulfonate, aluminum sulfate, aluminum sulfite, aluminum thio sulfate, polyaluminum chloride, basic polyaluminum hydroxide, aluminum sulfate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zinc phenolsulfonate, zirconium acetate, zirconium chloride, zirconium chloride oxide octahydrate, zirconium hydroxychloride, chromium acetate, magnesium sulfate, magnesium chloride hexahydrate, magnesium citrate nonahydrate, sodium phosphotungstate, tungsten sodium citrate and 12-tungstophosphoric acid n-hydrate. Some of these have unsuitably low pH values, and may thus be used after appropriate adjustment of the pH. The term “water-soluble”, as used herein in reference to the water-soluble polyvalent metal salt, means solubility of 1 mass % or greater in water at ordinary temperature, ordinary pressure. Water-soluble metal salts comprising zirconium and aluminum are preferred for the invention. Water-soluble metal salts comprising zirconium include the product ZA-30 by Daiichi Kigenso Kagaku Kogyo Co., Ltd., for example. Examples of readily obtainable water-soluble metals comprising aluminum include those marketed under the name Polyaluminum Chloride (PAC) by Taki Chemical Co., Ltd. as water treatment agents, under the name Polyaluminum Hydroxide (Paho) by Asada Chemical Industry Co., Ltd., or under the name PURACHEM WT by Riken Green Co., Ltd., or various grades marketed by other manufacturers for the same purpose.

The image-receiving layer may also comprise a binder. The binder content in the image-receiving layer is preferably no greater than 10 mass % and more preferably no greater than 6 mass % of the solid coating weight of the image-receiving layer. This can result in excellent printing durability. The binder used may be the same hydrophilic binder in the second image-receiving layer formed between the image-receiving layer and support, as described hereunder. The solid coating weight of the image-receiving layer is preferably 0.01-8.0 g/m², more preferably 0.05-2.0 g/m² and even more preferably 0.05-1.5 g/m².

A lithographic printing original plate made by an ink-jet system, to be used for the invention, preferably has a second image-receiving layer provided between the image-receiving layer and the support. The second image-receiving layer may be a polymer type image-receiving layer, as mentioned above, but it is preferably an image-receiving layer composed mainly of inorganic fine particles. This can yield a lithographic printing original plate with excellent image quality, printing durability and toning resistance. When a second image-receiving layer is provided between the image-receiving layer and the support, the solid coating weight of the entire image-receiving layer is preferably 10-50 g/m².

The second image-receiving layer will now be described. The second image-receiving layer is composed mainly of inorganic fine particles. Here, “composed mainly of inorganic fine particles” means comprising at least 50 mass %, more preferably at least 60 mass % and even more preferably 65-90 mass % inorganic fine particles, with respect to the solid coating mass of the second image-receiving layer.

The inorganic fine particles in the second image-receiving layer may be any of the various known types of fine particles such as amorphous synthetic silica, alumina, alumina hydrate, calcium carbonate, magnesium carbonate or titanium dioxide, with amorphous synthetic silica, alumina and alumina hydrate being preferred from the viewpoint of productivity. From the viewpoint of ink absorbency, it is preferable to use amorphous synthetic silica, and especially fumed silica, described below. The mean secondary particle size of the inorganic fine particles in the second image-receiving layer is preferably less than 1.0 μm. The more preferred mean secondary particle size is no greater than 500 nm.

Amorphous synthetic silica may be largely classified as wet silica, fumed silica, or other types, according to the method of production. Wet silica is further classified as precipitated silica, gel silica or sol silica, according to the method of production. Precipitated silica is produced by reacting sodium silicate and sulfuric acid under alkaline conditions, with aggregation and precipitation of the grown silica particles, followed by filtration, washing, drying, pulverizing and sorting to obtain a product. Precipitated silica is commercially available as NIPSIL by Tosoh Silica Corp., or as TOKUSIL by Tokuyama Corp. Gel silica is produced by reacting sodium silicate and sulfuric acid under acidic conditions. The maturing microparticles are dissolved and redeposited so as to bind to other primary particles, and therefore distinct primary particles are lost, forming relatively hard aggregated particles with an interior void structure. These are commercially available, for example, as NIPGEL by Tosoh Silica Corp. and SILOID or SILOJET by Grace Co., Japan. Sol silica is also known as colloidal silica, and is obtained by double decomposition of sodium silicate with an acid or heat maturation of silica sol obtained through an ion exchange resin layer, being commercially available as SNOWTEX by Nissan Chemical Industries, Ltd., for example.

Fumed silica is also known as dry silica, in contrast to wet silica, and it is generally produced by flame hydrolysis. Specifically, methods of combustion of silicon tetrachloride together with hydrogen and oxygen are generally known, and silanes such as methyltrichlorosilane or trichlorosilane instead of silicon tetrachloride may also be used, either alone or in admixture with silicon tetrachloride. Fumed silica is commercially available as AEROSIL by Nippon Aerosil Co., Ltd. and as QS Type by Tokuyama Corp.

The inorganic fine particles have a BET specific surface area exceeding 150 m²/g, which is preferred for improving the toning resistance.

Preferred among such inorganic fine particles are fumed silica particles with a BET specific surface area exceeding 300 m²/g. The term “BET”, as used herein, refers to a method of measuring the surface area of powder by gas phase adsorption, determining the total surface area of 1 g of sample from the absorption isotherm, i.e. the area-to-weight ratio. Nitrogen gas is widely used as adsorption gas, and the most widely used method involves measurement of the adsorption by changes in the pressure or the volume of the adsorption gas. Most noted for representing the isotherm of multimolecular adsorption is the Brunauer-Emmett-Teller formula, or BET formula, which is widely employed for detecting surface area. The adsorption is determined based on the BET formula, and the surface area is determined by multiplying it by the area of the surface occupied by one adsorbed molecule.

Fumed silica is preferably dispersed in the presence of a cationic compound. The mean secondary particle size of dispersed fumed silica is preferably less than 1.0 μm. The dispersion method preferably involves pre-mixing the fumed silica and dispersing medium by common propeller stirring, turbine stirring, homomixer stirring or the like, followed by dispersion using a media mill such as a ball mill, bead mill or sand grinder, a pressure disperser such as a high-pressure homogenizer or ultrahigh-pressure homogenizer, an ultrasonic disperser or a thin-film spinning disperser. The mean secondary particle size of the inorganic fine particles according to the invention may be measured as the number median diameter using a laser scattering particle size distribution meter (for example, an LA910 by Horiba, Ltd.).

It is preferred to use wet silica pulverized to a mean secondary particle size of less than 1.0 μm. The wet silica used is preferably precipitated silica or gel silica, and especially precipitated silica. The wet silica preferably consists of wet silica particles with a mean aggregated particle diameter of 5-50 μm, and there may be used wet silica fine particles that have been finely milled in the presence of a cationic compound.

Wet silica produced by a common method has a mean aggregated particle diameter of 1.0 μm or greater, and may be finely pulverized for use. The pulverizing method used is preferably a wet dispersion method in which the silica dispersed in the aqueous medium is mechanically pulverized. In order to inhibit increase in the initial viscosity of the dispersion, allowing high-concentration dispersion and increasing the pulverizing and dispersion efficiency for pulverization into more fine particles, it is preferred to use precipitated silica with a mean aggregated particle diameter of 5 μm or greater. Using a high-concentration dispersion will improve the productivity of the lithographic printing original plate.

A specific method for obtaining wet silica fine particles with a mean secondary particle size of less than 1.0 μm will now be described. First, silica particles and a cationic compound are combined in a dispersing medium composed mainly of water, and a pre-dispersion is prepared using at least one dispersing apparatus such as a sawtooth blade disperser, a propeller blade disperser or a rotor stator disperser. If necessary, a suitable low-boiling-point solvent or the like may be added to the aqueous dispersion medium. Although a higher solid concentration is preferred for the silica pre-dispersion, an excessively high concentration will make dispersion impossible, and therefore the preferred range is 15-40 mass % and more preferably 20-35 mass %. The silica pre-dispersion is then subjected to mechanical means with strong shearing force to pulverize the silica particles, to obtain a wet silica fine particle dispersion with a mean secondary particle size of less than 1.0 μm. A known method may be employed as the mechanical means, and for example, a media mill such as a ball mill, bead mill or sand grinder, a pressure disperser such as a high-pressure homogenizer or ultrahigh-pressure homogenizer, or an ultrasonic disperser or thin-film spinning disperser may be used.

The cationic compound used for dispersion or pulverizing of fumed silica and wet silica is preferably a cationic polymer. Such cationic compounds and cationic polymers are the same as the cationic compounds used together with colloidal silica in the image-receiving layer of the invention, with diallylamine derivatives being particularly preferred as cationic polymers. From the viewpoint of dispersibility and dispersion viscosity, the molecular weights of such cationic polymers are preferably about 2000-100,000 and especially about 2000-30,000.

The inorganic fine particles used in the second image-receiving layer may also be alumina or alumina hydrate particles. Alumina or alumina hydrates are aluminum oxide and its hydrates, which may be crystalline or amorphous, and in forms that are indefinite, spherical, tabular or the like. Any of these may be used, optionally in combinations.

Alumina oxide to be used is preferably γ-alumina, which is the γ crystal form of aluminum oxide, with δ group crystals being especially preferred. γ-Alumina can have primary particles reduced to about 10 nm, but for most purposes, it may be secondary particle crystals of several thousand to several tens of thousands of nm, dispersed to a mean secondary particle size of less than 1.0 μm for use with ultrasonic waves or a high-pressure homogenizer or a turbulent opposed jet pulverizer.

Alumina hydrate to be used has the compositional formula Al₂O₃.nH₂O (n=1-3). An aluminum oxide hydrate can be obtained by a known production method, such as hydrolysis of an aluminum alkoxide such as aluminum isopropoxide, neutralization of an aluminum salt with an alkali, or hydrolysis of an aluminic acid salt. The mean secondary particle size of the alumina hydrate that is used is preferably less than 1.0 μm.

The alumina or alumina hydrate used is preferably dispersed to a mean secondary particle size of less than 1.0 μm using a known dispersing agent such as acetic acid, lactic acid, formic acid, methanesulfonic acid, hydrochloric acid or nitric acid.

Two or more different types of inorganic fine particles from among the aforementioned inorganic fine particles may also be used in combination. Examples include a combination of finely milled wet silica and fumed silica, a combination of finely milled wet silica and alumina or alumina hydrate, and a combination of fumed silica and alumina or alumina hydrate. The proportion for combined use is preferably in the range of 7:3-3:7 in all cases.

The content of inorganic fine particles in the second image-receiving layer is preferably 50 mass % or greater, more preferably 60 mass % or greater, and especially in the range of 65-90 mass %, with respect to the total solid content of the image-receiving layer. Such an image-receiving layer with a high content ratio of inorganic fine particles can serve as a porous image-receiving layer with a high void percentage.

A binder is preferably used together with the inorganic fine particles composing the second image-receiving layer. The binder used is preferably a hydrophilic binder which has high transparency and results in higher permeability of the ink. Examples of such hydrophilic binders include polyvinyl alcohol and its modified forms, gelatin, polyethylene oxide, polyvinylpyrrolidone, polyacrylic acid, polyacrylamide, polyurethane, dextran, dextrin, carrageenan, agar, pullulan, water-soluble polyvinyl butyral, hydroxyethylcellulose, carboxylmethyl cellulose and the like. These hydrophilic binders may also be used in combinations of two or more. When a hydrophilic binder is used, it is important for the hydrophilic binder not to swell and block the voids during the initial penetration of the ink, and from this viewpoint, it is preferred to use a hydrophilic binder with relatively low expansion near room temperature. Preferred hydrophilic binders are totally or partially saponified polyvinyl alcohols, and cation-modified polyvinyl alcohols.

Most preferred among polyvinyl alcohols are partially and totally saponified polyvinyl alcohols with saponification degrees of 80% and greater. The mean polymerization degree is preferably 200-5000.

A cation-modified polyvinyl alcohol is a polyvinyl alcohol having a primary to tertiary amino group or a quaternary ammonium group in the main chain or a side chain of the polyvinyl alcohol, as described in Japanese Unexamined Patent Publication SHO No. 61-10483, for example.

When such a hydrophilic binder is used in the second image-receiving layer, a hardener may be used as necessary. Specific examples of hardeners include aldehyde-based compounds such as formaldehyde and glutaraldehyde, ketone compounds such as diacetyl and chlorpentanedione, reactive halogen-containing compounds such as bis(2-chloroethyl)urea, 2-hydroxy-4,6-dichloro-1,3,5-triazine and those mentioned in U.S. Pat. No. 3,288,775, reactive olefin-containing compounds such as divinylsulfone and those mentioned in U.S. Pat. No. 3,635,718, the N-methylol compounds mentioned in U.S. Pat. No. 2,732,316, the isocyanato compounds mentioned in U.S. Pat. No. 3,103,437, the aziridine compounds mentioned in U.S. Pat. No. 3,017,280 and U.S. Pat. No. 2,983,611, the carbodiimide-based compounds mentioned in U.S. Pat. No. 3,100,704, the epoxy compounds mentioned in U.S. Pat. No. 3,091,537, halogen carboxyaldehydes such as mucochloric acid, dioxane derivatives such as dihydroxydioxane, and inorganic crosslinking agents such as chrome alum, zirconium sulfate, borax, boric acid and boric acid salts, any of which may be used alone or in combinations of 2 or more.

When a partially or totally saponified polyvinyl alcohol with a saponification degree of 80% or greater is used as the hydrophilic binder, borax, boric acid or a boric acid salt is preferred, with boric acid being especially preferred.

Hydrophilic binders that may be used in the second image-receiving layer include hydrophilic binders with keto groups. A hydrophilic binder with a keto group can be synthesized by copolymerization of a keto group-containing monomer and another monomer. Specific examples of keto group-containing monomers include acrolein, diacetoneacrylamide, diacetone methacrylate, acetoacetoxyethyl methacrylate, 4-vinylacetoacetoanilide and acetoacetylallylamide. Keto groups may also be introduced during the polymer reaction, such as by introducing acetoacetyl groups via reaction between hydroxy groups or amino groups with a diketene. Specific examples of keto group-containing hydrophilic binders include acetoacetyl-modified polyvinyl alcohols, acetoacetyl-modified cellulose derivatives, acetoacetyl-modified starch, diacetoneacrylamide-modified polyvinyl alcohols, and the hydrophilic binders mentioned in Japanese Unexamined Patent Publication HEI No. 10-157283. According to the invention, keto group-containing modified polyvinyl alcohols are preferred. Specific examples of keto group-containing modified polyvinyl alcohols include acetoacetyl-modified polyvinyl alcohols and diacetoneacrylamide-modified polyvinyl alcohols.

Acetoacetyl-modified polyvinyl alcohols can be produced by known methods such as reaction between polyvinyl alcohols and diketenes. The acetoacetylation degree is preferably 0.1-20 mol % and more preferably 1-15 mol %. The saponification degree is preferably 80 mol % or greater and more preferably 85 mol % or greater. The polymerization degree is preferably 500-5000 and most preferably 2000-4500.

Diacetoneacrylamide-modified polyvinyl alcohols can be produced by known methods such as saponification of diacetoneacrylamide-vinyl acetate copolymers. The diacetoneacrylamide unit content is preferably in the range of 0.1-15 mol % and more preferably in the range of 0.5-10 mol %. The saponification degree is preferably 85 mol % or greater, and the polymerization degree is preferably 500-5000.

A keto group-containing hydrophilic binder optionally included in the second image-receiving layer is preferably crosslinked with a crosslinking agent. The following compounds may be mentioned as crosslinking agents.

### (1) Polyamines

### Aliphatic Polyamines:

Alkylenediamines (for example, ethylenediamine, propylenediamine, trimethylenediamine, tetramethylenediamine and hexamethylenediaminc)
Polyalkylenepolyamines (for example, diethylenetriamine, iminobis(propylamine), bis(hexamethylene)triamine, triethylenetetramine, tetraethylenepentamine and pentaethylenehexamine)
Alkyl- or hydroxyalkyl-substituted forms of the foregoing (for example, aminoethylethanolamine and methyliminobis(propylamine))
Alicyclic or heterocyclic group-containing aliphatic polyamines (for example, 3,9-bis(3-aminopropyl)-2,4,8,10-tetraoxaspiro[5,5]undecane)
Aromatic ring-containing aliphatic amines (for example, xylylenediamine and tetrachlor-p-xylylenediamine)

C4-C15 alicyclic polyamines such as 1,3-diaminocyclohexane, isophorone diamine, menthanediamine and 4,4′-methylenedicyclohexanediamine (hydrogenated methylenedianiline).

C4-C15 heterocyclic polyamines such as piperazine, N-aminoethylpiperazine and 1,4-diaminopiperazine.

C6-C20 aromatic polyamines:
Unsubstituted aromatic polyamines (for example, 1,2-, 1,3- and 1,4-phenylenediamine, 2,4′- and 4,4′-diphenylmethanediamine, polyphenylpolymethylenepolyamine, diaminodiphenylsulfone, benzidine, thiodianiline, bis(3,4-diaminophenyl)sulfone, 2,6-diaminopyridine, m-aminobenzylamine, triphenylmethane-4,4′,4″-triamine and naphthylenediamine)
Aromatic polyamines with nucleosubstituted alkyl groups (such as C₁-C₄ alkyl groups) (for example, 2,4- and 2,6-tolylenediamine, crude tolylenediamine, diethyltolylenediamine, 4,4′-diamino-3,3′-dimethyldiphenylmethane, 4,4′-bis(o-toluidine), dianisidine, diaminoditolylsulfone, 1,3-dimethyl-2,4-diaminobenzene, 1,3-diethyl-2,4-diaminobenzene, 1,3-dimethyl-2,6-diaminobenzene, 1,4-diethyl-2,5-diaminobenzene, 1,4-diisopropyl-2,5-diaminobenzene, 1,4-dibutyl-2,5-diaminobenzene, 2,4-diaminomesitylene, 1,3,5-triethyl-2,4-diaminobenzene, 1,3,5-triisopropyl-2,4-diaminobenzene, 1-methyl-3,5-diethyl-2,4-diaminobenzene, 1-methyl-3,5-diethyl-2,6-diaminobenzene, 2,3-dimethyl-1,4-diaminonaphthalene, 2,6-dimethyl-1,5-diaminonaphthalene, 2,6-diisopropyl-1,5-diaminonaphthalene, 2,6-dibutyl-1,5-diaminonaphthalene, 3,3′,5,5′-tetramethylbenzidine, 3,3′,5,5′-tetraisopropylbenzidine, 3,3′,5,5′-tetramethyl-4,4′-diaminodiphenylmethane, 3,3′,5,5′-tetraethyl-4,4′-diaminodiphenylmethane, 3,3′,5,5′-tetraisopropyl-4,4′-diaminodiphenylmethane, 3,3′,5,5′-tetrabutyl-4,4′-diaminodiphenylmethane, 3,5-diethyl-3′-methyl-2′,4-diaminodiphenylmethane, 3,5-diisopropyl-3′-methyl-2′,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraisopropyl-4,4′-diaminobenzophenone, 3,3′,5,5′-tetraethyl-4,4′-diaminodiphenyl ether and 3,3′,5,5′-tetraisopropyl-4,4′-diaminodiphenylsulfone)

### Polyamidepolyamines:

For example, low molecular weight polyamidepolyamines (for example, with a molecular weight of 200-5000), obtained by condensation of a dicarboxylic acid (dimer acid or the like) with an excess of a polyamine (at 2 mol or greater per mole of acid) (such as an alkylenediamine or polyalkylenepolyamine as mentioned above).

### Polyetherpolyamines:

For example, hydrogenated forms of cyanoethylated polyether polyols (such as polyalkylene glycols) with molecular weights of 100-5000.

### (2) Dicyandiamide Derivatives:

Dicyandiamide, dicyandiamide/formalin polycondensate, dicyandiamide/diethylenetriamine polycondensate, and the like.

### (3) Hydrazine Compounds:

Hydrazine, monoalkylhydrazines and inorganic salts of hydrazine (for example, inorganic salts with hydrochloric acid, sulfuric acid, nitric acid, nitrous acid, phosphoric acid, thiocyanic acid and carbonic acid), and organic salts of hydrazine (for example, organic salts with formic acid and oxalic acid).

### (4) Polyhydrazide Compounds (Dihydrazide, Trihydrazide):

Carbohydrazide, succinic acid dihydrazide, adipic acid dihydrazide, citric acid trihydrazide, sebacic acid dihydrazide, isophthalic acid dihydrazide and terephthalic acid dihydrazide.

### (5) Aldehydes;

Mono aldehydes such as formaldehyde, acetaldehyde, propionaldehyde, butylaldehyde, crotonaldehyde and benzaldehyde, dialdehydes such as glyoxal, malondialdehyde, succindialdehyde, glutardialdehyde, maleindialdehyde, 1,8-octanedial, phthalaldehyde, isophthalaldehyde, terephthalaldehyde and PVA that has been aldehydated at both ends, side chain aldehyde-containing copolymers obtained by saponification of allylidene-vinyl acetate diacetate copolymer, dialdehyde starches, polyacrolein, and the like.

### (6) Methylol Compounds;

Methylolphosphine, dimethylolurea, dimethylolmelamine, trimethylolmelamine, urea resin prepolymers, melamine resin prepolymers and the like.

### (7) Activated Vinyl Compounds;

Divinylsulfone-based compounds, β-hydroxyethylsulfone-based compounds, and the like.

### (8) Epoxy Compounds;

Epichlorohydrin, ethyleneglycol diglycidyl ether, polyethyleneglycol diglycidyl ether, glycerin di- or triglycidyl ether, 1,6-hexanediol diglycidyl ether, trimethylolpropanetriglycidyl ether, diglycidylaniline, diglycidylamine, polyepoxy compounds, and the like.

### (9) Isocyanate-Based Compounds;

Tolylene diisocyanate, tolylene hydride diisocyanate, trimethylolpropane-tolylene diisocyanate adduct, triphenylmethane triisocyanate, methylenebis-4-phenylmethane triisocyanate, isophorone diisocyanate, ketooxime block forms or phenol block forms of the foregoing, polyisocyanates, and the like.

### (10) Phenol-Based Compounds;

Phenol-based resin precondensates, resorcinol-based resins, and the like.

### (11) Polyvalent Metal Salts;

Zirconium salts (zirconium nitrate, basic zirconium carbonate, zirconium acetate, zirconium sulfate, zirconium oxychloride, zirconium chloride, zirconium hydroxychloride, zirconium carbonate, zirconiumlammonium carbonate, zirconium/potassium carbonate, zirconium fluoride compounds, and the like)
Titanium salts (titanium tetrachloride, titanium lactate, tetraisopropyl titanate, and the like)
Aluminum salts (aluminum chloride, aluminum sulfate, aluminum lactate, and the like)
Calcium salts (calcium chloride, calcium sulfate, calcium acetate, calcium propionate, and the like)
Magnesium salts (magnesium chloride, magnesium sulfate, and the like)
Zinc salts (zinc chloride, zinc sulfate, zinc acetate, and the like)

Preferred among these crosslinking agents are polyhydrazide compounds and polyvalent metal salts. Dihydrazide compounds are most preferred, among polyhydrazide compounds, with adipic acid dihydrazide and succinic acid dihydrazide being especially preferred. Zirconium salts are more preferred as polyvalent metal salts, with zirconium oxychloride and zirconium nitrate being especially preferred. The amount of crosslinking agent added is appropriately in the range of 1-40 mass %, preferably 2-30 mass % and more preferably 3-20 mass %, with respect to the keto group-containing hydrophilic binder. A hardener may also be used therewith, as the keto group-containing hydrophilic binder has a structure similar to ordinary polyvinyl alcohol at portions other than the acetoacetyl-modified or diacetoneacrylamide-modified sites. It is particularly preferred to use borax, boric acid or a boric acid salt.

A totally or partially saponified polyvinyl alcohol or a cation-modified polyvinyl alcohol may be used in combination with a keto group-containing hydrophilic binder, in which case a hardener or crosslinking agent may also be used in combination therewith.

Other known hydrophilic binders may also be used in combination therewith. For example, cellulose derivatives such as carboxymethylcellulose and hydroxypropylcellulose, starch and various modified starches, gelatin and various modified gelatin forms, chitosan derivatives, carrageenan, casein, soybean protein, polyvinyl alcohol and various modified polyvinyl alcohols, polyvinylpyrrolidone, polyacrylamide and the like, may be used in combination therewith as necessary. Various types of latexes may also be used as binders.

The content of the binder in the second image-receiving layer is preferably in the range of 5-40 mass % and more preferably in the range of 10-30 mass % with respect to the inorganic fine particles that are the major component of the image-receiving layer, to allow formation of fine voids in the image-receiving layer to produce a porous layer.

The dry coating amount of the second image-receiving layer is preferably in the range of 10-50 g/m², more preferably 12-40 g/m² and even more preferably 15-35 g/m², calculated based on the inorganic fine particles. The image-receiving layer may further contain a cationic polymer, antiseptic agent, surfactant, coloration, dye, color pigment, ultraviolet absorber, antioxidant, pigment dispersing agent, antifoaming agent, leveling agent, fluorescent whitening agent, viscosity stabilizer, pH regulator or the like.

An interlayer may also be provided between the image-receiving layer and the second image-receiving layer.

The water-resistant support of the lithographic printing plate which is made by an ink-jet system, to be used for the invention, is a plastic resin film, for example, a polyester resin such as polyethylene terephthalate, or a diacetate resin, triacetate resin, acrylic resin, polycarbonate resin, polyvinyl chloride, polyimide resin, cellophane, celluloid or the like, or a laminate of paper and a resin film, or a polyolefin resin-coated sheet obtained by coating both sides of a base sheet with a polyolefin resin layer. The thickness of such a water-resistant support is 50-350 μm and preferably 80-300 μM.

A polyolefin resin-coated sheet support (hereunder referred to as “polyolefin resin-coated sheet”) will now be explained in detail. A polyolefin resin-coated sheet to be used for the invention is not particularly restricted in its water content, but this is preferably in the range of 5-9% and more preferably 6-9%, for the curling property. The water content of the polyolefin resin-coated sheet can be measured by any desired method. For example, an infrared moisture meter, an absolute dry weight method, a permittivity method or a Karl Fischer method may be employed.

There are no particular restrictions on the base sheet composing the polyolefin resin-coated sheet, and it may be any commonly used sheet, but it is more preferably smooth base paper such as is used in photograph supports. The pulp in the base sheet may be natural pulp, regenerated pulp or synthetic pulp, either alone or as mixtures of 2 or more. The base sheet may also contain additives commonly used for papermaking, such as sizing agents, paper strength additives, loading materials, antistatic agents, fluorescent whitening agents or dyes. The surface may also be coated with a surface sizing agent, surface strength agent, fluorescent whitening agent, antistatic agent, dye, anchoring agent or the like.

There are no particular restrictions on the thickness of the base sheet, but it preferably has good surface smoothness by application of pressure by calendering during or after sheet making, and the basis weight is preferably 30-250 g/m².

The polyolefin resin covering the base sheet is an olefin homopolymer such as low-density polyethylene, high-density polyethylene, polypropylene, polybutene or polypentene, or a copolymer of 2 or more olefins, such as ethylene-propylene copolymer, or a mixture thereof, and any one having any density or melt viscosity index (melt index), or a mixture thereof, may be used.

The resin in the polyolefin resin-coated sheet may contain various additives as appropriate, including white pigments such as titanium oxide, zinc oxide, talc or calcium carbonate, fatty acid amides such as stearic acid amide or arachidic acid amide, fatty acid metal salts such as zinc stearate, calcium stearate, aluminum stearate or magnesium stearate, blue pigments or dyes such as cobalt blue, ultramarine blue, cerulean blue or phthalocyanine blue, magenta pigments or dyes such as cobalt violet, Fast Violet or manganese violet, fluorescent whitening agents, ultraviolet absorbers, and the like.

The main method used to produce a polyolefin resin-coated sheet is the extrusion coating method wherein a hot molten polyolefin resin is cast onto a running base sheet, for covering of both sides of a base sheet with a resin. Prior to covering the base sheet with the resin, the base sheet is preferably subjected to activating treatment such as corona discharge treatment or flame treatment. A suitable thickness for the resin covering layer is 5-50 μm.

An undercoat layer is also preferably provided on the side of the water-resistant support on which the image-receiving layer is to be coated. The undercoat layer is precoated and dried on the surface of the water-resistant support before the image-receiving layer is coated. The undercoat layer is composed mainly of a film-forming water-soluble polymer or polymer latex. Water-soluble polymers such as gelatin, polyvinyl alcohol, polyvinylpyrrolidone and water-soluble cellulose are preferred, with gelatin being most preferred. The coverage of such a water-soluble polymer is preferably 10-500 mg/m² and more preferably 20-300 mg/m². The undercoat layer also preferably comprises a surfactant or a hardener. Providing an undercoat layer on the support can effectively prevent crazing during coating of the image-receiving layer, to obtain a uniform coated surface.

There are no particular restrictions on the method of coating the image-receiving layer and second image-receiving layer, and a coating applicator such as a slide bead coater, curtain coater, extrusion coater, air knife coater, rod coater, blade coater or gravure coater may be used, alone or in combinations. When the image-receiving layer and second image-receiving layer are to be coated simultaneously, a coating applicator such as a slide bead coater or curtain coater may be used. When the image-receiving layer is to be coated subsequent to coating of the second image-receiving layer, a combination of the aforementioned coating applicators may be used. Simultaneous coating means that each layer is coated at approximately the same time. Subsequent coating means that the coating solution for the upper layer is coated after voids of the lower layer have been formed from the decreasing rate of drying step onward.

The ink used for printing of image data with an ink-jet system, with the image-receiving layer of the lithographic printing original plate of the invention, may be any of various types of ink including aqueous ink, solid ink, UV ink or oil-based ink. However, because solid ink and UV ink have high ink viscosity during discharge, it is difficult to discharge fine ink droplets to allow high-resolution plate making images, while generation of nonaqueous solvent vapor by the oil-based ink renders it unsuitable for use in offices, and printed images tend to bleed, making it difficult to obtain high-resolution plate-making images. Therefore, aqueous ink is preferred as the ink for printing on lithographic printing plates. Aqueous pigment inks are especially preferred among aqueous inks.

After the heat-sensitive lithographic printing plate or the lithographic printing plate which is made by an ink-jet system according to the invention, is made without developing treatment using a heat-sensitive printing method or an ink-jet printing method, non-image section desensitizing treatment is preferably carried out before printing is started. Examples for the treatment solution to be used for such desensitizing treatment include inorganic fine particle-containing treatment solutions such as described in Japanese Unexamined Patent Publication HEI No. 5-289341, Japanese Unexamined Patent Publication HEI No. 7-56349, Japanese Examined Patent Publication SHO No. 45-29001 and Japanese Examined Patent Publication SHO No. 61-28987, and treatment solutions containing colloidal fine particles or hygroscopic polyols, such as described in Japanese Examined Patent Publication SHO No. 56-41992. The treatment solution may be applied onto the plate surface by a method of hand etching in which the treatment solution is impregnated into absorbent cotton or the like for thorough application to the plate surface, a method in which a fixed amount of the treatment solution is applied with a bar coater, or a method using an etching converter, involving dipping into a liquid bath retaining the treatment solution and removal of the excess treatment solution with a roll pair.

### Embodiment 2

### Lithographic Printing Method

The lithographic printing method of this embodiment is a lithographic printing method comprising: obtaining a fountain solution composition for a lithographic printing plate comprising at least one polyols, and using the fountain solution composition for a lithographic printing plate at a working concentration such that the concentration of the polyol is 1.5-25 mass %, for printing using a lithographic printing plate that does not require developing treatment during plate making. The lithographic printing method of this embodiment is a lithographic printing method comprising: using a fountain solution composition for a lithographic printing plate comprising at least one polyols at 1.5-25 mass % for printing using a lithographic printing plate that does not require developing treatment during plate making. This embodiment has essentially the same construction and effect as embodiment 1 described above, and explanation of the corresponding aspects will not be repeated.

A fountain solution composition for a lithographic printing plate comprising at least one polyols can be obtained by mixing the necessary components with water, as explained above. The fountain solution composition for a lithographic printing plate may be diluted with water if necessary, and the fountain solution composition for a lithographic printing plate may be used at a working concentration such that the concentration of the polyols is 1.5-25 mass %, to allow use in a printer employing a lithographic printing plate. The printer employing the lithographic printing plate may be a commercially available one or any other type of printer for lithographic printing.

The invention will now be explained in greater detail through examples, with the understanding that the invention is in no way limited by these examples. The “parts” represent parts by mass of the solid portion or real portion.

### EXAMPLES

### Example 1

A first coating solution having the formulation of image-forming layer coating solution (a) (image-forming layer (A)) and a second coating solution having the formulation of image-forming layer coating solution (b) (image-forming layer (B)) were prepared, and applied onto one side of an approximately 180 μm-thick polyethylene cover sheet that had been laminated on both sides, using a slide hopper coating method for simultaneous coating to a wet coating amount of 30 g/m² on the first layer and 10 g/m² on the second layer, after which these were dried to form an image-forming layer.

The compounds of formulas (1) to (4), the developers and the coloring agents were individually subjected to microdispersion treatment beforehand with a solid concentration of 30% using zirconia beads in a mini-Dyno-Mill (bead mill), and used in the form of dispersions.

<Image-Forming Layer Coating Solution (a)>

| | |
|---|---|
| Water-soluble polymer compound | |
| Gelatin: IK3000, solid weight: | 1.05 kg |
| (product of Nippi, Inc.) | |
| Thermoplastic resin | |
| Carboxylated SBR resin: LACSTAR 7132C, solid weight: | 1.70 kg |
| (product of DIC) | |
| Surfactant | |
| NIKKOL OTP-75, solid weight: | 0.02 kg |
| (product of Nikko Chemicals Co., Ltd.) | |
| Curing agent | |
| 1,3-Vinylsulfony1-2-propanol, solid weight: | 0.15 kg |
| Compound of formulas (1) to (4) | |
| 1,2-bis(3-Methylphenoxy)ethane, solid weight: | 1.95 kg |
| Developer | |
| 4-Hydroxy-4′-isopropoxydiphenylsulfone, solid weight: | 1.95 kg |
| (product of Nippon Soda Co., Ltd.) | |
| Coloring agent | |
| 3-Dibutylamino-6-methyl-7-anilinofluorane, solid weight: | 0.30 kg |
| (product of Yamamoto Chemicals, Inc.) | |
| Heat-fusible substance | |
| Montanic acid ester wax: HYDRIN J-537, solid weight: | 0.40 kg |
| (product of Chukyo Yushi Co., Ltd.) | |
| The total amount was adjusted to 40 kg with water. | |

<Image-Forming Layer Coating Solution (b)>

| | |
|---|---|
| Water-soluble polymer compound | |
| Gelatin: IK3000, solid weight: | 1.70 kg |
| (product of Nippi, Inc.) | |
| Thermoplastic resin | |
| Carboxylated SBR resin: LACSTAR 7132C, solid weight: | 1.15 kg |
| (product of DIC) | |
| Surfactant | |
| NIKKOL OTP-75, solid weight: | 0.02 kg |
| (product of Nikko Chemicals Co., Ltd.) | |
| Curing agent | |
| 1,3-Vinylsulfony1-2-propanol, solid weight: | 0.15 kg |
| Compound of formulas (1) to (4) | |
| 1,2-bis(3-Methylphenoxy)ethane, solid weight: | 0.00 kg |
| Developer | |
| 4-Hydroxy-4′-isopropoxydiphenylsulfone, solid weight: | 0.00 kg |
| (product of Nippon Soda Co., Ltd.) | |
| Coloring agent | |
| 3-Dibutylamino-6-methyl-7-anilinofluorane, solid weight: | 0.30 kg |
| (product of Yamamoto Chemicals, Inc. | |
| Heat-fusible substance | |
| Montanic acid ester wax: HYDRIN J-537, solid weight: | 0.40 kg |
| (product of Chukyo Yushi Co., Ltd.) | |
| The total amount was adjusted to 40 kg with water. | |

An image was recorded on a heat-sensitive lithographic printing plate prepared in this manner with a direct thermal printer (barcode printer B-433: line-type thermal head: 300 dpi, by Toshiba Tec Corp.) in test print mode (printing speed: 2-inch/sec, applied energy: 18.6 mJ/mm²), to produce a printing plate.

### <Printing Evaluation 1>

Lead edge toning was evaluated in the following manner. A printing evaluation image was formed under the plate making conditions described above, and used as a printing sample in a printing test. The printer used was a HAMADA DU341IC (offset printer by Hamada Printing Press Co., Ltd.), the ink was SO Process PG Black N (product of Megami Ink Manufacturing Co., Ltd.), and the fountain solution was prepared with fountain solution formulation 1 listed in Table 1 and used directly as a working solution. Before the start of printing, a 25% aqueous solution of TDP-HL (etching solution, product of Mitsubishi Paper Mills, Ltd.) was thoroughly smeared onto the plate surface using absorbent cotton, and then printing was initiated at a speed of 4000 sheets/hr, for printing of 3000 sheets each. The lead edge toning was evaluated by visually determining whether or not ink from the tips of the printing plate is gradually accumulated, and the ink transferred to a printed sheet surface and caused toning of the print, and whether or not the ink accumulated on the tips of the plate after printing was complete, based on the following scale.

### <Lead Edge Toning>

Good (G): No toning on tips of prints, and no accumulation of ink on tips of plate after completion of printing.

Good/Fair (G/F): No toning on tips of prints, but some accumulation of ink on tips of plate after completion of printing.

Poor (P): Toning on tips of prints.

The results are shown in Table 2.

### <Fountain Solution Formulation 1>

Additives in Table 1

| | |
|---|---|
| Sodium dihydrogen phosphate | 0.45 g |
| Colloidal silica (SNOWTEX C), solid weight: | 0.50 g |
| BIOACE | 0.05 g |
| Sodium nitrate | 0.10 g |
| Adjusted to pH 6 with sodium hydroxide. | |
| Adjusted to 1 kg with water. | |

TABLE 1

| | | | Amount | Combined | sp | Amount |
|---|---|---|---|---|---|---|
| | No. | Additive | (g) | additive | value | (g) |
| Comparison | 1 | GL | 10 | — | — | |
| Invention | 2 | GL | 20 | — | — | — |
| Invention | 3 | GL | 30 | — | — | — |
| Invention | 4 | GL | 50 | — | — | — |
| Invention | 5 | GL | 100 | — | — | — |
| Invention | 6 | GL | 200 | — | — | — |
| Comparison | 7 | GL | 300 | — | — | — |
| Invention | 8 | TPG | 30 | — | — | — |
| Invention | 9 | DPG | 30 | — | — | — |
| Invention | 10 | PG | 30 | — | — | — |
| Invention | 11 | TEG | 30 | — | — | — |
| Invention | 12 | EG | 30 | — | — | — |
| Invention | 13 | GL | 30 | EG | 36.5 | 4 |
| Invention | 14 | GL | 30 | BTG | 22.9 | 4 |
| Invention | 15 | GL | 30 | MFTG | 21.4 | 4 |
| Invention | 16 | GL | 30 | PG | 32.6 | 4 |
| Invention | 17 | GL | 30 | TPG | 25.3 | 10 |
| Invention | 18 | GL | 30 | TPG | 25.3 | 20 |
| Invention | 19 | GL | 30 | TPG | 25.3 | 40 |
| Comparison | 20 | — | — | — | — | — |

GL: Glycerin
PG: Propylene glycol
DPG: Dipropylene glycol
TPG: Tripropylene glycol
MFTG: Propyleneglycol mono-n-butyl ether
EG: Ethylene glycol
TEG: Triethylene glycol
BTG: Butyl triglycol

### <Printing Evaluation 2>

The initial ink receptivity and printing durability were evaluated in the following manner. The printer used was a HAMADA H234C (offset printer by Hamada Printing Press Co., Ltd.), the ink was NEW CHAMPION FG Black N (product of DIC Corporation), and the fountain solution was prepared with fountain solution formulation 1 listed in Table 1 and used directly. Before the start of printing, a 25% aqueous solution of SLM-OD30 (fountain solution by Mitsubishi Paper Mills, Ltd.) was thoroughly smeared onto the plate surface using absorbent cotton, and then, for evaluation under forced conditions, a 0.1 mm gauge film was sandwiched between the printing cylinder and the plate and printing was initiated at a speed of 8000 sheets/hr with the printing pressure raised. The ink receptivity property was evaluated under the following scale as the number of sheets printed from the start of printing until uniform run-over of ink. The printing durability was evaluated under the following scale, as the number of sheets in which print image defects were produced and no printing was possible.

### <Ink Receptivity Property>

Good (G): Less than 10 sheets.

Good/Fair (G/F): At least 10 and less than 20 sheets.

Fair (F): At least 20 and less than 50 sheets.

Poor (P): At least 50 sheets.

The results are shown in Table 2.

### <Printing Durability>

Very Good (VG): At least 5000 sheets.

Good (G): At least 4000 and less than 5000 sheets.

Good/Fair (G/F): At least 2000 and less than 4000 sheets.

Poor (P): Less than 2000 sheets.

The results are shown in Table 2.

<Printing evaluation 3>

The printing evaluation for scumming was conducted in the following manner. The printer used was a Ryobi 3200CD (by Ryobi Imagix Co.), the ink was NEW CHAMPION FG Violet 68S (product of DIC Corporation), and the fountain solution was prepared with fountain solution formulation 1 listed in Table 1 and used directly. Before the start of printing, a 20% aqueous solution of SLM-OD₃₀ (fountain solution by Mitsubishi Paper Mills, Ltd.) was thoroughly smeared onto the plate surface using absorbent cotton, and then, for evaluation under forced conditions, a 0.1 mm gauge film was sandwiched between the printing cylinder and the plate, 2000 sheets were printed at a printing speed of 7000 sheets/hr with the printing pressure raised, and the number of sheets with toning (scumming) at the non-image sections of the print were evaluated based on the following scale.

### <Scumming>

Good (G): At least 2000 sheets.

Good/Fair (G/F): At least 1500 and less than 2000 sheets.

Fair (F): At least 1000 and less than 1500 sheets.

Poor (P): Less than 1000 sheets.

The results are shown in Table 2.

TABLE 2

| | | Lead edge | Ink | Printing | |
|---|---|---|---|---|---|
| | No. | toning | receptivity | durability | Scumming |
| Comparison | 1 | P | G | VG | F |
| Invention | 2 | G/F | G | VG | G |
| Invention | 3 | G | G | VG | G/F |
| Invention | 4 | G | G | VG | G/F |
| Invention | 5 | G | G | VG | G/F |
| Invention | 6 | G | G/F | VG | G/F |
| Comparison | 7 | G | F | G | F |
| Invention | 8 | G/F | G/F | G | G/F |
| Invention | 9 | G/F | G/F | G | G/F |
| Invention | 10 | G/F | G | VG | G/F |
| Invention | 11 | G/F | G | G | G/F |
| Invention | 12 | G/F | G | VG | G/F |
| Invention | 13 | G | G | VG | G/F |
| Invention | 14 | G | G | VG | G |
| Invention | 15 | G | G | VG | G |
| Invention | 16 | G | G | VG | G |
| Invention | 17 | G | G | VG | G |
| Invention | 18 | G | G | VG | G |
| Invention | 19 | G | G/F | G | G/F |
| Comparison | 20 | P | G | VG | F |

### Example 2

### Fabrication of Water-Resistant Support

A 1:1 mixture of broadleaf tree bleached Kraft pulp (LBKP) and broadleaf tree bleached sulphite pulp (LBSP) was beaten to 300 ml by Canadian Standard Freeness, to prepare a pulp slurry. To this there were added a sizing agent and alkylketene dimer at 0.5 mass % with respect to the pulp, polyacrylamide as a strength agent at 1 mass % with respect to the pulp, cationized starch at 2 mass % with respect to the pulp and a polyamide epichlorhydrin resin at 0.5 mass % with respect to the pulp, and the mixture was diluted with water to prepare a 0.2 mass % slurry. The slurry was made into a sheet with a wire paper machine to a basis weight of 170 g/m², and dried and humidified to prepare a support base sheet. A polyethylene resin composition comprising 10 mass % anatase titanium dioxide homogeneously dispersed in a low-density polyethylene resin with a density of 0.918 g/cm³ was melted at 320° C., and extruded at 200 m/min to a thickness of 30 μm onto the printed side of the prepared base sheet, and used to form a resin covering layer on the image-receiving layer-coated side while cooling with a finely roughened cooling roll. On the opposite side, a blend resin composition comprising 70 parts of high-density polyethylene resin with a density of 0.962 g/cm³ and 30 parts of low-density polyethylene resin with a density of 0.918 g/cm³ was melted at 320° C. in the same manner, and a resin covering layer was formed to a thickness of 25 μm while cooling with a cooling roll.

After subjecting the image-receiving layer-coated side of the water-resistant support to high-frequency corona discharge treatment, a base coating layer with the following composition was coated and dried to a gelatin coverage of 50 mg/m².

### <Base Coating Layer>

| | |
|---|---|
| Lime-treated gelatin | 100 parts |
| 2-Ethylhexyl sulfosuccinate ester salt | 2 parts |
| Chrome alum | 10 parts |

Coating solution 1 for a second image-receiving layer having the following composition was coated onto the water-resistant support to a solid weight of 25 g/m² using a slide bead coater, and after cooling at 5° C. for 30 seconds, it was completely dried at 40° C., 10% RH, and coating solution 2 for an image-receiving layer having the following composition was subsequently coated to a colloidal silica solid weight of 1 g/m² using a gravure coater, and dried at 50° C.

### <Fumed Silica Dispersion 1>

After adding 3 parts of dimethyldiallylaluminum chloride homopolymer (molecular weight: 9000) and 100 parts of fumed silica (mean primary particle size: 7 nm, specific surface area: 300 m²/g) to water to prepare a pre-dispersion, it was treated with a high-pressure homogenizer to prepare fumed silica dispersion 1 having a solid concentration of 20 mass %. The mean secondary particle size of the fumed silica was 80 nm, as measured with a laser diffraction/scattering particle size distribution analyzer.

### <Coating Solution 1>

| | |
|---|---|
| Fumed silica dispersion 1 | 103 parts |
| Boric acid | 5 parts |
| Polyvinyl alcohol | 23 parts |
| (saponification degree: 88%, mean polymerization degree: 3500) | |

The solid concentration was adjusted to 12 mass % with water.

### <Coating Solution 2>

| | |
|---|---|
| Cationic colloidal silica | 100 parts |
| (SNOWTEX ST-AK-YL (product of Nissan Chemical | |
| Industries, Ltd.), having a mean primary particle size of 40-50 | |
| nm and colloidal particles as the spherical primary particles.) | |
| Polyvinyl alcohol | 4 parts |
| (saponification degree: 88%, mean polymerization degree: | |
| 3500) | |
| Surfactant (SWANOL AM, product of Nihon Surfactant | 0.3 parts |
| Kogyo K.K.) | |

The solid concentration was adjusted to 8 mass % with water.

The lithographic printing original plate prepared in this manner was used to record an image (cyan ink) using an ink jet printer (PX-1001 by Seiko Epson Corp.) employing an aqueous pigment ink, to produce a lithographic printing plate.

### <Printing Evaluation 1>

The lead edge toning was evaluated in the same manner as Example 1, except that a fountain solution with the fountain solution formulation 2 shown below, prepared as shown in Table 3, was used as the fountain solution. The results are shown in Table 4.

### <Fountain Solution Formulation 2>

Additives in Table 3

| | |
|---|---|
| Sodium dihydrogen phosphate | 0.45 g |
| Colloidal silica (SNOWTEX C), solid weight: | 0.50 g |
| BIOACE | 0.05 g |
| Sodium nitrate | 0.10 g |
| Adjusted to pH 6 with sodium hydroxide. | |
| Adjusted to 1 kg with water. | |

TABLE 3

| | | | Amount | Combined | sp | Amount |
|---|---|---|---|---|---|---|
| | No. | Additive | (g) | additive | value | (g) |
| Comparison | 21 | GL | 10 | — | — | — |
| Invention | 22 | GL | 75 | — | — | — |
| Invention | 23 | GL | 100 | — | — | — |
| Invention | 24 | GL | 200 | — | — | — |
| Comparison | 25 | GL | 300 | — | — | — |
| Invention | 26 | TPG | 75 | — | — | — |
| Invention | 27 | DPG | 75 | — | — | — |
| Invention | 28 | PG | 75 | — | — | — |
| Invention | 29 | TEG | 75 | — | — | — |
| Invention | 30 | EG | 75 | — | — | — |
| Invention | 31 | GL | 75 | EG | 36.5 | 4 |
| Invention | 32 | GL | 75 | BTG | 22.9 | 4 |
| Invention | 33 | GL | 75 | MFTG | 21.4 | 4 |
| Invention | 34 | GL | 75 | PG | 32.6 | 4 |
| Invention | 35 | GL | 75 | TPG | 25.3 | 10 |
| Invention | 36 | GL | 75 | TPG | 25.3 | 20 |
| Invention | 37 | GL | 75 | TPG | 25.3 | 40 |
| Comparison | 38 | — | — | — | — | — |

GL: Glycerin
PG: Propylene glycol
DPG: Dipropylene glycol
TPG: Tripropylene glycol
MFTG: Propyleneglycol mono-n-butyl ether
EG: Ethylene glycol
TEG: Triethylene glycol
BTG: Butyl triglycol

### <Printing Evaluation 2>

The initial ink receptivity and printing durability were evaluated in the same manner as Example 1, except for using a fountain solution prepared with fountain solution formulation 2 shown below, prepared as shown in Table 3, as the fountain solution. The results are shown in Table 4.

### <Printing Evaluation 3>

The printing evaluation for scumming was conducted in the same manner as Example 1, except that a fountain solution with the fountain solution formulation 2 shown below, prepared as shown in Table 3, was used as the fountain solution. The results are shown in Table 4.

TABLE 4

| | | Lead edge | Ink | Printing | |
|---|---|---|---|---|---|
| | No. | toning | receptivity | durability | Scumming |
| Comparison | 21 | P | G | VG | F |
| Invention | 22 | G | G | VG | G/F |
| Invention | 23 | G | G | VG | G/F |
| Invention | 24 | G | G | VG | G/F |
| Comparison | 25 | G | F | G | F |
| Invention | 26 | G/F | G/F | G | G/F |
| Invention | 27 | G/F | G/F | G | G/F |
| Invention | 28 | G/F | G | G | G/F |
| Invention | 29 | G/F | G | G | G/F |
| Invention | 30 | G/F | G | G | G/F |
| Invention | 31 | G | G | VG | G/F |
| Invention | 32 | G | G | VG | G |
| Invention | 33 | G | G | VG | G |
| Invention | 34 | G | G | VG | G |
| Invention | 35 | G | G | VG | G |
| Invention | 36 | G | G | VG | G |
| Invention | 37 | G | G | G | G |
| Comparison | 38 | P | G | VG | F |

As demonstrated by these results, lithographic printing using a fountain solution composition for a lithographic printing plate according to the invention drastically improved lead edge toning without impairing the other printing properties, compared to the comparative examples.

1. A fountain solution composition for a lithographic printing plate,
comprising at least one polyols,
to be used at a working concentration such that the concentration of the polyols is 1.5-25 mass % when printing using a lithographic printing plate that does not require developing treatment during plate making.

2. A fountain solution composition for a lithographic printing plate,
comprising at least one polyols at 1.5-25 mass %,
to be used for printing using a lithographic printing plate that does not require developing treatment during plate making.

3. A fountain solution composition for a lithographic printing plate according to claim 1, wherein at least one of the polyols is glycerin.

4. A fountain solution composition for a lithographic printing plate according to claim 1, wherein the fountain solution composition for a lithographic printing plate comprises 2 or more polyols, at least one of the polyols being a polyol with an sp value of no greater than 35.

5. A fountain solution composition for a lithographic printing plate according to claim 1, wherein the lithographic printing plate that does not require developing treatment during plate making is a lithographic printing plate made by an ink-jet system.

6. A fountain solution composition for a lithographic printing plate according to claim 1, wherein the lithographic printing plate that does not require developing treatment during plate making is a heat-sensitive lithographic printing plate.

7. A lithographic printing method, the method comprising:
obtaining a fountain solution composition for a lithographic printing plate comprising at least one polyols, and
using the fountain solution composition for a lithographic printing plate at a working concentration such that the concentration of the polyols is 1.5-25 mass %, for printing using a lithographic printing plate that does not require developing treatment during plate making.

8. A lithographic printing method, the method comprising:
using a fountain solution composition for a lithographic printing plate comprising at least one polyols at 1.5-25 mass % for printing using a lithographic printing plate that does not require developing treatment during plate making.

9. A lithographic printing method according to claim 7, wherein at least one of the polyols is glycerin.

10. A lithographic printing method according to claim 7, wherein the fountain solution composition for a lithographic printing plate comprises 2 or more polyols, at least one of the polyols being a polyol with an sp value of no greater than 35.

11. A lithographic printing method according to claim 7, wherein the lithographic printing plate that does not require developing treatment during plate making is a lithographic printing plate made by an ink-jet system.

12. A lithographic printing method according to claim 7, wherein the lithographic printing plate that does not require developing treatment during plate making is a heat-sensitive lithographic printing plate.

13. A fountain solution composition for a lithographic printing plate according to claim 2, wherein at least one of the polyols is glycerin.

14. A fountain solution composition for a lithographic printing plate according to claim 2, wherein the fountain solution composition for a lithographic printing plate comprises 2 or more polyols, at least one of the polyols being a polyol with an sp value of no greater than 35.

15. A fountain solution composition for a lithographic printing plate according to claim 2, wherein the lithographic printing plate that does not require developing treatment during plate making is a lithographic printing plate made by an ink-jet system.

16. A fountain solution composition for a lithographic printing plate according to claim 2, wherein the lithographic printing plate that does not require developing treatment during plate making is a heat-sensitive lithographic printing plate.

17. A lithographic printing method according to claim 8, wherein at least one of the polyols is glycerin.

18. A lithographic printing method according to claim 8, wherein the fountain solution composition for a lithographic printing plate comprises 2 or more polyols, at least one of the polyols being a polyol with an sp value of no greater than 35.

19. A lithographic printing method according to claim 8, wherein the lithographic printing plate that does not require developing treatment during plate making is a lithographic printing plate made by an ink-jet system.

20. A lithographic printing method according to claim 8, wherein the lithographic printing plate that does not require developing treatment during plate making is a heat-sensitive lithographic printing plate.
